(19) United States
(12) Patent Application Publication
(10) Pub. No.: US 2024/0224218 A1
(43) Pub. Date: Jul. 4, 2024

(54) METHOD AND DEVICE FOR GENERATING POSITIONING REFERENCE SIGNAL IN WIRELESS COMMUNICATION SYSTEM

(71) Applicant: Innovative Technology Lab Co., Ltd., Seoul (KR)

(72) Inventor: Sung Jun YOON, Seoul (KR)

(21) Appl. No.: 18/002,683

(22) PCT Filed: Sep. 2, 2021
(86) PCT No.: PCT/KR2021/011813

§ 371 Date: Jun. 15, 2023

(30) Foreign Application Priority Data
Sep. 4, 2020 (KR) 10-2020-0112998

(51) Int. Cl. H04W 64/00; H04L 5/00

(52) U.S. Cl. CPC H04W 64/00; H04L 5/0051

(57) ABSTRACT

A method for estimating a location of a terminal in a wireless communication system. At this time, the method for estimating the position of the terminal is a step of receiving DL PRS configuration information from the base station, the received DL PRS configuration information comprises comb size and DL PRS allocation pattern information, the comb size and the DL PRS allocation pattern It may comprise receiving a DL PRS from the base station based on and estimating a location based on the received DL PRS.

### TECHNICAL FIELD

The present disclosure relates to a method for generating a positioning reference signal (PRS) in a wireless communication system. Specifically, it relates to a method and apparatus for generating a PRS for positioning in New Radio (NR).

### BACKGROUND

The Positioning may refer to an operation of estimating a location. In the case of estimating the position of a terminal based on positioning in a wireless communication system, even if some errors exist in position estimation, requirements considering use cases or scenarios must be satisfied. Here, the horizontal positioning requirement may be set within 3 m (80%) according to the internal environment scenario of the applied wireless communication system, and the horizontal positioning requirement may be set within 10 m (80%) as the external environment scenario.

On the other hand, when considering Industrial Internet of Things (IIoT) as a new application and industrial structure, requirements for positioning errors may be set high. For example, a requirement for sub-meter level positioning error may be set within 1 m. In addition, the requirement for positioning error for IIOT can be set within 0.2 m.

Therefore, there is a need for a new positioning reference signal (PRS) generation method for positioning to satisfy the requirements required according to the development of wireless communication systems and technological changes.

### DETAILED DESCRIPTION

### Technical Subject

The technical problem of the present disclosure may provide a method and apparatus for generating a location reference signal (PRS) in a wireless communication system.

The present disclosure may provide a method and apparatus for generating a position reference signal (PRS) for positioning in consideration of an IIOT environment in a wireless communication system.

The present disclosure may provide a method and apparatus for generating a position reference signal (PRS) for positioning in a new radio (NR) system.

The present disclosure may provide a method and apparatus for generating a downlink PRS (DL PRS) in a wireless communication system.

The present disclosure may provide a method and apparatus for generating a sounding reference signal (SRS) for positioning in a wireless communication system.

The technical problems to be achieved in the present disclosure are not limited to the technical problems mentioned above, and other technical problems not mentioned will be clearly understood by those skilled in the art from the description below.

### Technical Solution

It relates to a partial sensing method and apparatus for communication between terminals in a wireless communication system according to an aspect of the present disclosure.

In a method for estimating a position of a terminal in a wireless communication system according to an aspect of the present disclosure, as a step of receiving downlink positioning reference signal (DL PRS) configuration information from a base station, the reception of the DL PRS configuration information includes comb size and DL PRS allocation pattern information, receiving a DL PRS from the base station based on the comb size and the DL PRS allocation pattern, and determining a location based on the received DL PRS including the step of estimating, wherein the DL PRS resource related ID is distinguished based on a time axis shift value and a frequency axis shift value based on the DL PRS allocation pattern, and the terminal is related to the DL PRS resource. The DL PRS can be received based on the ID.

In addition, according to an aspect of the present disclosure, the terminal receives bitmap information indicating the DL PRS muting from the base station, performs the DL PRS muting based on the received bitmap information, and the bitmap information includes at least one of first bitmap information, second bitmap information, and third bitmap information, wherein the first bitmap information indicates muting for the DL PRS in units of occasions, and the second bitmap information may indicate muting for the DL PRS in units of repetition within the occasion, and the third bitmap information may indicate muting for the DL PRS in units of a plurality of symbols within the repetition.

In addition, in the method for estimating a position of a terminal in a wireless communication system according to an aspect of the present disclosure, as a step of receiving SRS (Sounding Reference Signal) transmission related information for positioning from a base station, the SRS transmission related information includes a comb size and a cyclic shift (CS) number including at least one of size information and PRB (Physical Resource Block) information and based on the received SRS transmission related information, and the determined comb size and the determined CS. It may include transmitting the SRS based on the number.

### Effect

According to the present disclosure, a method and apparatus for generating a PRS for positioning in a wireless communication system may be provided.

According to the present disclosure, a method for performing positioning with high accuracy in consideration of Industrial Internet of Things (IIoT) scenarios may be provided.

According to the present disclosure, a method for allocating a downlink/uplink (DL/UL) location reference signal for positioning with high accuracy may be provided.

According to the present disclosure, signaling/procedure for improving positioning accuracy, reduced delay, and a method for improving network efficiency and terminal efficiency may be provided.

According to the present disclosure, a method for allocating a plurality of PRSs to one slot with a DL (Downlink) PRS allocation pattern with increased orthogonality to satisfy positioning requirements for low delay in downlink may be provided. Here, the DL PRS allocation pattern may increase orthogonality in one slot through shifts in the time axis and frequency axis, and through this, it is possible to satisfy the low delay requirement for positioning.

According to the present disclosure, a PRS muting pattern may be provided as a method of reducing PRS overhead in order to prevent collisions between a plurality of Transmission Reception Points (TRPs) in downlink.

According to the present disclosure, a method of determining a comb size and a physical resource block (PRB) for transmitting a sounding reference signal (SRS) for positioning in uplink may be provided.

Effects obtainable in the present disclosure are not limited to the effects mentioned above, and other effects not mentioned may be clearly understood by those skilled in the art from the description below.

### BRIEF DESCRIPTION OF THE DRAWINGS

FIG. 1 is a diagram for explaining an NR frame structure to which the present disclosure may be applied.

FIG. 2 is a diagram showing a NR resource structure to which the present disclosure can be applied.

FIG. 3 is a diagram illustrating a method of performing location measurement based on OTDOA (Observed Time Difference Of Arrival) to which the present disclosure may be applied.

FIG. 4 shows a configuration diagram of a control plane and a user plane for an LTE positioning protocol (LPP) related to the present invention to which the present disclosure may be applied.

FIG. 5 is a diagram showing a comb pattern applicable to the present disclosure.

FIG. 6 is a diagram illustrating a method of increasing orthogonality for DL PRS resource allocation applicable to the present disclosure.

FIG. 7 is a diagram illustrating a case where a DL PRS pattern of comb size 12 applicable to the present disclosure is a diagonal pattern.

FIG. 8 is a diagram illustrating a pattern maintaining orthogonality after cyclic prefix in a DL PRS pattern of comb size 12 applicable to the present disclosure.

FIG. 9 is a diagram illustrating a DL PRS pattern of comb size 6 applicable to the present disclosure.

FIG. 10 is a diagram illustrating a method of performing cyclic prefix based on a current DL PRS allocation pattern applicable to the present disclosure.

FIG. 11 is a diagram illustrating a method of performing cyclic prefix based on a current DL PRS allocation pattern applicable to the present disclosure.

FIG. 12 is a diagram illustrating a method of performing cyclic prefix based on a DL PRS allocation pattern in which orthogonality is maintained even after cyclic prefix applicable to the present disclosure.

FIG. 13 is a diagram illustrating a method of performing cyclic prefix based on a DL PRS allocation pattern in which orthogonality is maintained even after cyclic prefix applicable to the present disclosure.

FIG. 14 is a diagram illustrating a method of performing cyclic prefix based on a DL PRS allocation pattern that maintains orthogonality even after cyclic prefix applicable to the present disclosure.

FIG. 15 is a diagram illustrating a DL PRS resource allocation method applicable to the present disclosure.

FIG. 16 is a diagram illustrating an additional bitmap applicable to the present disclosure.

FIG. 17 is a diagram illustrating an additional bitmap applicable to the present disclosure.

FIG. 18 is a diagram illustrating an additional bitmap applicable to the present disclosure.

FIG. 19 is a flowchart for explaining an example of a method of generating a PRS applicable to the present disclosure.

FIG. 20 is a flowchart for explaining an example of a method of generating an SRS applicable to the present disclosure.

FIG. 21 is a diagram illustrating a base station device and a terminal device to which the present disclosure can be applied.

### BEST MODE TO CARRY OUT THE INVENTION

Hereinafter, with reference to the accompanying drawings, embodiments of the present disclosure will be described in detail so that those skilled in the art can easily implement the present disclosure. However, this disclosure may be embodied in many different forms and is not limited to the embodiments set forth herein.

In describing the embodiments of the present disclosure, if it is determined that a detailed description of a known configuration or function may obscure the gist of the present disclosure, a detailed description thereof will be omitted. And, in the drawings, parts irrelevant to the description of the present disclosure are omitted, and similar reference numerals are assigned to similar parts.

In the present disclosure, when a component is said to be “connected”, “coupled” or “connected” to another component, this is not only a direct connection relationship, but also an indirect connection relationship where another component exists in the middle. may also be included. In addition, when a component “includes” or “has” another component, this means that it may further include another component without excluding other components unless otherwise stated.

In the present disclosure, terms such as first and second are used only for the purpose of distinguishing one element from another, and do not limit the order or importance of elements unless otherwise specified. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly explain each characteristic, and do not necessarily mean that the components are separated. That is, a plurality of components may be integrated to form a single hardware or software unit, or a single component may be distributed to form a plurality of hardware or software units. Accordingly, even such integrated or distributed embodiments are included in the scope of the present disclosure, even if not mentioned separately.

In the present disclosure, components described in various embodiments do not necessarily mean essential components, and some may be optional components. Accordingly, an embodiment comprising a subset of elements described in one embodiment is also included in the scope of the present disclosure. In addition, embodiments including other components in addition to the components described in various embodiments are also included in the scope of the present disclosure.

The present disclosure describes a wireless communication network, and operations performed in the wireless communication network are performed in the process of controlling the network and transmitting or receiving signals in a system (for example, a base station) that manages the wireless communication network, or It may be performed in a process of transmitting or receiving a signal from a terminal coupled to a wireless network.

It is obvious that various operations performed for communication with a terminal in a network composed of a plurality of network nodes including a base station may be performed by the base station or other network nodes other than the base station. ‘Base Station (BS)’ may be replaced by terms such as fixed station, Node B, eNodeB (eNB), ng-eNB, gNodeB (gNB), and access point (AP). In addition, ‘terminal’ will be replaced with terms such as User Equipment (UE), Mobile Station (MS), Mobile Subscriber Station (MSS), Subscriber Station (SS), and non-AP STA.

In the present disclosure, transmitting or receiving a channel means transmitting or receiving information or a signal through a corresponding channel. For example, transmitting a control channel means transmitting control information or a signal through the control channel. Similarly, transmitting a data channel means transmitting data information or a signal through the data channel.

In the following description, the term NR (New Radio) system is used for the purpose of distinguishing a system to which various examples of the present disclosure are applied from an existing system, but the scope of the present disclosure is not limited by these terms.

The NR system supports various subcarrier spacing (SCS) considering various scenarios, service requirements, and potential system compatibility. In addition, the NR system uses multiple channels to overcome poor channel environments such as high path-loss, phase-noise, and frequency offset occurring on a high carrier frequency. It is possible to support transmission of a physical signal/channel through a beam of. Through this, the NR system can support applications such as eMBB (enhanced mobile broadband), mMTC (massive machine type communications)/uMTC (ultra machine type communications), and URLLC (ultra reliable and low latency communications).

Hereinafter, 5G mobile communication technology may be defined to include not only the NR system, but also the existing Long Term Evolution-Advanced (LTE-A) system and Long Term Evolution (LTE) system. 5G mobile communication may include a technology that operates in consideration of backward compatibility with the previous system as well as the newly defined NR system. Therefore, the following 5G mobile communication may include a technology operating based on the NR system and a technology operating based on the previous system (e.g., LTE-A, LTE), and is not limited to a specific system.

The positioning field to which the present invention is applied relates to positioning technology in the NR system, and may include some positioning technology in the LTE system in consideration of backward compatibility with previous systems. Hereinafter, for convenience of description, an operation for positioning and related information based on the NR system will be described. However, the features of the embodiments of the present disclosure may not be applied limitedly to a specific system, may equally be applied to other systems implemented similarly, and are not limited to exemplary systems to which the embodiments of the present disclosure are applied.

First, the physical resource structure of the NR system to which the present invention is applied will be briefly described.

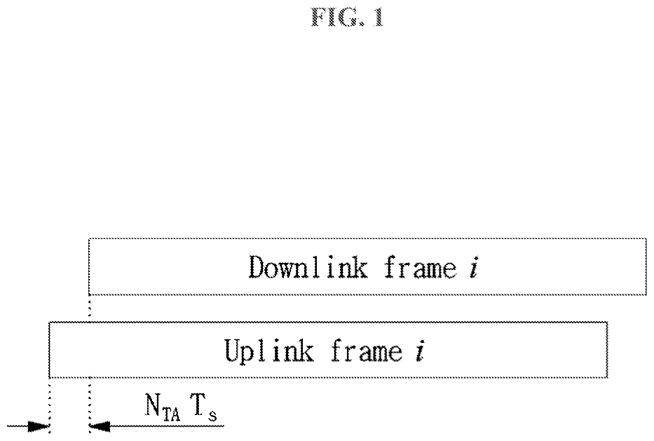

FIG. 1 is a diagram for explaining an NR frame structure to which the present disclosure may be applied.

In NR, the basic unit of the time domain may be T_{c}=1/(Δfₘₐₓ·N_{f}), Δfₘₐₓ=480·10³, and N_{f}=4096. Meanwhile, in LTE, the time domain basic unit may be Ts=1/(Δf_{ref}·N_{f,ref}), Δf_{ref}=15·10³, and N_{f,ref}=2048. A constant for the multiple relationship between the NR time base unit and the LTE time base unit may be defined as κ=Tₛ/T_{c}=64.

Referring to FIG. 1, a time structure of a frame for downlink/uplink (DL/UL) transmission may have T_{f}=(Δfₘₐₓ·N_{f}/100)·Tₛ=10 ms. Here, one frame consists of 10 subframes corresponding to the time of T_{sf}=(Δfₘₐₓ·N_{f}/1000)·Tₛ=1 ms. The number of consecutive OFDM symbols per subframe may be N^{subframe.u}_{symb}=N^{slot}_{symb}·N^{subframe,u}ₛₗₒₜ. In addition, each frame is divided into two half frames of the same size, half frame 1 may be composed of subframes 0-4, and half frame 2 may be composed of subframes 5-9.

NTA represents a timing advance (TA) between downlink (DL) and uplink (UL). Here, the transmission timing of the uplink transmission frame i is determined based on Equation 1 below based on the downlink reception timing at the terminal.

$${T}_{TA} = ( {N}_{TA} \cdot {N}_{TA , offset} ) \cdot {T}_{c} \qquad [ Equation 1 ]$$

Here, N_{TA,offset} may be a TA offset value generated by a duplex mode difference or the like. In frequency division duplex (FDD), N_{TA,offset} has a value of 0, but in time division duplex (TDD), it may be defined as a fixed value of N_{TA,offset} in consideration of a margin for DL-UL switching time. For example, N_{TA,offset} may be 39936 T_{c} or 25600 T_{c} in Time Division Duplex (TDD) of frequency range 1 (FR1), which is a frequency of sub-6 GHz or less. The 39936 T_{c} is 20.327 μs and the 25600 T_{c} is 13.030 μs. In addition, NTA offset may be 13792 T_{c} in a frequency range 2 (FR2) that is a mm Wave frequency. At this time, 39936 T_{c} is 7.020 μs.

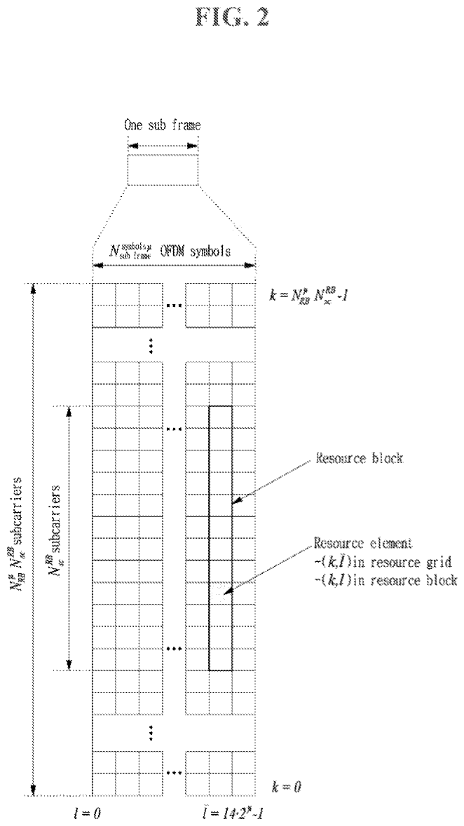

FIG. 2 is a diagram showing a NR resource structure to which the present disclosure can be applied.

A resource element (RE) in a resource grid may be indexed according to each subcarrier spacing. Here, one resource grid may be generated for each antenna port and each subcarrier spacing. Uplink and downlink transmission and reception may be performed based on a corresponding resource grid.

One resource block (RB) in the frequency domain is composed of 12 REs, and an index (n_{PRB}) for one RB may be configured for each 12 REs. An index for an RB may be utilized within a specific frequency band or system bandwidth. An index for RB may be defined as in Equation 2 below. Here, N^{RB}_{sc} means the number of subcarriers per one RB, and k means a subcarrier index.

$${n}_{PRB} = ⌊ \frac{k}{{N}_{sc}^{RB}} ⌋ \qquad [ Equation 2 ]$$

Various numerologies can be set to satisfy various services and requirements of the NR system. For example, one subcarrier spacing (SCS) can be supported in an LTE/LTE-A system, but a plurality of SCSs can be supported in an NR system.

A new numerology for NR systems supporting multiple SCS is a frequency range such as 700 MHz or 2 GHz, or to solve the problem of not being able to use a wide bandwidth in a carrier, 3 GHz or less, 3 GHZ-6 GHz, or in a frequency range or carrier such as 6 GHZ-52.6 GHz.

Table 1 below shows examples of numerologies supported by the NR system.

TABLE 1

| u | Δf = 2^{u} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Referring to Table 1, the numerology may be defined based on subcarrier spacing (SCS) used in an orthogonal frequency division multiplexing (OFDM) system, cyclic prefix (CP) length, and the number of OFDM symbols per slot. The values may be provided to the UE through higher layer parameters DL-BWP-mu and DL-BWP-cp for downlink and UL-BWP-mu and UL-BWP-cp for uplink.

In Table 1, when the subcarrier spacing setting index u is 2, the subcarrier spacing Δf is 60 kHz, and a normal CP and an extended CP may be applied. In the case of other numerology indexes, only normal CP can be applied.

A normal slot can be defined as a basic time unit used to transmit basically one piece of data and control information in an NR system. The length of a normal slot can be set to the number of 14 OFDM symbols by default. Also, unlike a slot, a subframe has an absolute time length corresponding to 1 ms in the NR system and can be used as a reference time for the length of other time intervals. Here, for coexistence or backward compatibility between the LTE system and the NR system, a time interval such as a subframe of LTE may be required in the NR standard.

For example, in LTE, data may be transmitted based on a transmission time interval (TTI), which is a unit time, and the TTI may be set in units of one or more subframes. Here, one subframe may be set to 1 ms and may include 14 OFDM symbols (or 12 OFDM symbols).

Also, non-slots may be defined in NR. A non-slot may mean a slot having a number smaller than that of a normal slot by at least one symbol. For example, in the case of providing a low delay time such as URLLC service, the delay time can be reduced through non-slots having a smaller number of symbols than normal slots. Here, the number of OFDM symbols included in the non-slot may be determined in consideration of a frequency range. For example, in a frequency range of 6 GHz or higher, a non-slot having a length of 1 OFDM symbol may be considered. As a further example, the number of OFDM symbols defining a non-slot may include at least two OFDM symbols. Here, the range of the number of OFDM symbols included in the non-slot may be set as the length of a minislot up to a predetermined length (eg, normal slot length−1). However, as a non-slot standard, the number of OFDM symbols may be limited to 2, 4 or 7 symbols, but is not limited thereto.

In addition, for example, subcarrier spacings corresponding to u equal to 1 and 2 are used in unlicensed bands below 6 GHz, and subcarrier spacings corresponding to u equal to 3 and 4 may be used in unlicensed bands exceeding 6 GHz. For example, when u is 4, it may be used for SSB (Synchronization Signal Block).

TABLE 2

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot (N^{slot}_{symb}), the number of slots per frame (N^{frame,u}ₛₗₒₜ), and the number of slots per subframe (N^{subframe,u}ₛₗₒₜ) for each subcarrier spacing setting (u) in the case of a normal CP. Table 2 shows the above-described values based on a normal slot having 14 OFDM symbols.

TABLE 3

| u | N^{slot}_{symb} | N^{frame, u}ₛₗₒₜ | N^{subframe, u}ₛₗₒₜ |
|---|---|---|---|
| 2 | 12 | 40 | 4 |

Table 3 shows the number of slots per frame and the number of slots per subframe based on the normal slot where the number of OFDM symbols per slot is 12 when the extended CP is applied (ie, when u is 2 and the subcarrier spacing is 60 kHz).

As described above, one subframe may correspond to 1 ms on the time axis. Also, one slot may correspond to 14 symbols on the time axis. For example, one slot may correspond to 7 symbols on the time axis. Accordingly, the number of slots and symbols that can be considered can be set differently within 10 ms corresponding to one radio frame. Table 4 may indicate the number of slots and symbols according to each SCS. In Table 4, SCS of 480 kHz may not be considered, but is not limited to these examples.

TABLE 4

| | Number of slots within 10 ms | Number of slots within 10 ms | Number of symbols |
|---|---|---|---|
| SCS | (14 symbols in 1 slot) | (7 symbols in 1 slot) | in 10 ms |
| 15 kHz | 10 | 20 | 140 |
| 30 kHz | 20 | 40 | 280 |
| 60 kHz | 40 | 80 | 560 |
| 120 kHz | 80 | N/A | 1120 |
| 240 kHz | 160 | N/A | 2240 |
| 480 kHz | 320 | N/A | 4480 |

The positioning technology to which the present invention is applied is being further improved by using a new radio (NR) wireless technology based on long term evolution (LTE). In the case of commercial use, it includes technologies to satisfy an error of up to 3 m for indoor use and an error of up to 10 m for outdoor use for 80% of users within coverage. To this end, the following various technologies are being considered, such as a technology based on an arrival time and a technology based on a departure/arrival angle for downlink and/or uplink.

As a downlink-based method, as a time-based technology, there is a DL-TDOA (Time Difference of Arrival) method, and as an angle-based technology, DL-AoD (Angle of Departure) method. For example, when estimating the location of the UE based on DL-TDOA, the arrival time difference of signals transmitted from different transmission points is calculated, and the location of the UE is calculated based on the arrival time difference value and location information of each transmission point. In addition, as an example, when estimating the location of the terminal based on DL-AoD, the angle of departure of the signal transmitted to the terminal is checked, and the direction in which the signal is transmitted is checked based on the location of the transmission point. Location estimation of the terminal may be possible.

In addition, as an uplink-based method, as a time-based technology, there is a UL-TDOA (Time Difference of Arrival) method, and as an angle-based technology, a DL- There is an angle of arrival (AoA) method. For example, when estimating the location of a UE based on UL-TDOA, a time difference in arrival of a signal transmitted from the UE to each transmission point is calculated, and through the arrival time difference value and location information of each transmission point. Location estimation of the terminal may be possible. In addition, as an example, when estimating the location of the terminal based on DL-AoA, check the angle of arrival of the signal transmitted from the terminal, and check the direction in which the signal is transmitted based on the location of the transmission point. Thus, the location of the terminal may be estimated.

In addition, as a downlink and uplink-based method, a multi-cell RTT (Round-Trip Time) method, RTT between one or more neighboring gNBs and/or TRP (Transmission Reception Points) for NR downlink and uplink positioning method and E-CID (Enhanced Cell ID) method. For example, in case of estimating the location of the UE by multi-cell RTT, the time at which a signal is transmitted from a plurality of cells and a response is received (ie, RTT) is measured, and the location of the UE is determined through the location information of the plurality of cells. Estimation may be possible. In addition, location estimation of the UE may be possible by checking the RTT signal in gNBs and/or TRP. In addition, when estimating the location of the UE based on the E-CID, it is possible to estimate the location of the UE through cell location information by measuring the angle of arrival and reception strength to check each cell ID.

In order to realize the above-mentioned technologies, the LTE downlink-based Positioning Reference Signal (PRS) is newly discussed as “DL PRS” changed according to the NR downlink structure. Additionally, for uplink, NR considering MIMO, etc. SRS (Sounding Reference Signal), a base uplink reference signal, is being developed into “SRS for positioning”, a reference signal improved by considering positioning.

In addition, high accuracy for horizontal and vertical position measurement, low latency, network efficiency (e.g., scalability, RS overhead, etc) and terminal efficiency (e.g., power consumption, complexity, etc) are additionally considered.

As an example, the positioning operation may be considered a requirement to have high accuracy in consideration of the IIOT scenario. To this end, methods for improving downlink/uplink (DL/UL) location reference signals, signaling/procedures for improving accuracy, reduced delay, network efficiency, and UE efficiency may be considered.

Therefore, in commercial use cases such as IoT devices for smart homes or wearables and Industrial IoT (Inter of Things) (IIoT) use cases such as IoT devices in smart factories, higher accuracy and lower latency (Work to improve the performance of NR-based positioning technologies for latency and network/terminal efficiency is being applied.

In this regard, the goal is to increase accuracy with an error of up to 1 m for commercial use cases and within 0.2 m for IIoT use cases, and to further reduce the delay time from within 100 ms to less than 10 ms.

Here, IIOT scenarios considering indoor factory devices and the like may be shown in Table 5 below.

Specifically, the IIOT scenario may consider a case where clusters are dense (dense) and a case where clusters are not dense (sparse) in the internal environment. That is, it can be distinguished according to how many clusters exist in the internal environment. In addition, as an IIOT scenario, cases where the antenna height is higher or lower than the average height of the cluster can be considered. That is, the IIOT scenario may be as shown in Table 5 in consideration of the above cases.

That is, InF-SL is a scenario in which clusters are not densely clustered in an indoor factory environment such as a smart factory and both transmit and receive antennas of base stations are lower than the average antenna height of the cluster. Also, InF-DL is a scenario in which clusters are concentrated in an indoor factory environment such as a smart factory and both transmit and receive antennas of base stations are lower than the average antenna height of the cluster.

On the other hand, InF-SH is a scenario in which clusters are not densely clustered in an indoor factory environment such as a smart factory and the transmission or reception antenna of the base station is higher than the average antenna height of the cluster. In addition, InF-DH is a scenario considering the case where clusters are dense in an indoor factory environment such as a smart factory and the transmit or receive antenna of the base station is higher than the average antenna height of the cluster.

In addition, InF-HH is a scenario in which both transmit and receive antennas of a base station are higher than the average antenna height of a cluster regardless of cluster density in an indoor factory environment such as a smart factory.

Here, a cluster (clutter, cluster) means a form in which base stations are intensively arranged at regular intervals in a specific space. For example, a cluster may be implemented with 18 base stations in an internal environment, but this is only one example and is not limited thereto.

In addition, as mentioned above, considering the density of clusters and the height of antennas between base stations and clusters in scenarios, the characteristics of radio waves or interference vary accordingly, so various performance items required for positioning (accuracy, delay time, network/This is because the positioning technology to satisfy the terminal efficiency, etc.) may be slightly different.

However, in actual application, a common positioning technology that can cover all of the requirements in the above five scenarios can be applied, and the positioning technology to be described in the present invention below is also applicable to all of the above five scenarios. That is, positioning is possible by applying the positioning technology to be mentioned in the present invention to all IIoT devices operating based on NR in an indoor factory environment such as a smart factory.

TABLE 5
InF-SL : Indoor Factory with Sparse clutter and Low base station height (both Tx and Rx
are below the average height of the clutter)
InF-DL : Indoor Factory with Dense clutter and Low base station height (both Tx and Rx
are below the average height of the clutter)
InF-SH : Indoor Factory with Sparse clutter and High base station height (Tx or Rx elevated
above the clutter)
InF-DH : Indoor Factory with Dense clutter and High base station height (Tx or Rx elevated
above the clutter)
InF-HH : Indoor Factory with High Tx and High Rx (both elevated above the clutter)

In the following, a method of generating a PRS in consideration of the above-described IIoT scenario and positioning requirements in consideration of the new application will be described.

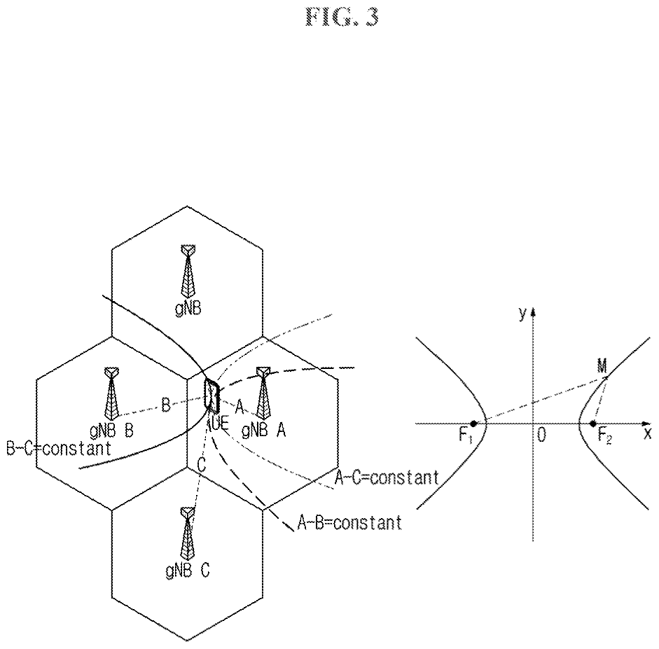

FIG. 3 is a diagram illustrating a method of performing location measurement based on OTDOA (Observed Time Difference Of Arrival) to which the present disclosure may be applied.

OTDOA may be a method of measuring a position by tracking a signal transmitted to a ground station through a communication satellite in an LTE and/or NR system. That is, OTDOA is based on measuring differences in arrival times of radio signals transmitted from various locations. For example, a plurality of cells may transmit a reference signal (RS) and the terminal may receive it. Since the distance between each of the plurality of cells and the location of the terminal is different, the arrival time at which the reference signal transmitted from each of the plurality of cells is received by the terminal may be different from each other. Here, the terminal may calculate the time difference for the signal received from each cell and transmit the calculated information to the network. The network can combine the time difference with each cell's antenna location information to calculate the location of the terminal. Here, at least three cells may be used to measure the location of the UE.

Also, as an example, a difference in time when a UE receives a reference signal from each of a pair of base stations (gNodeBs/eNodeBs) is defined as a Reference Signal Time Difference (RSTD). Here, location measurement by RSTD may be performed based on a downlink signal. The UE may estimate the location based on Time Difference Of Arrival (TDOA) measurement of a special reference signal received from other base stations (gNodeBs/eNodeBs).

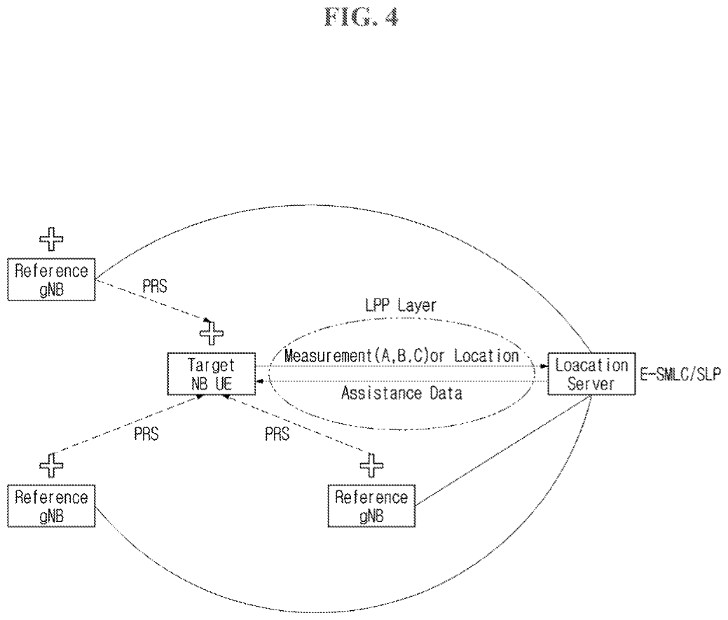

FIG. 4 shows a configuration diagram of a control plane and a user plane for an LTE positioning protocol (LPP) related to the present invention to which the present disclosure may be applied. For example, the positioning technology may be defined as at least one of E-CID (Enhanced Cell ID), OTDOA (Observed Time Difference of Arrival), and A-GNSS (Global Navigation Satellite System). In this case, the positioning technology described above may simultaneously support positioning solutions of the control plane and the user plane. The LTE and/or NR network-based positioning function can be managed by Evolved-Serving Mobile Location Center (E-SMLC)/Secure User Plane Location (SUPL) Location Platform (SLP). Here, positioning may be performed in the control plane through E-SMLC, and positioning may be performed in the user plane through SLP, and each is controlled at the network level to control a base station and a mobility entity (e.g., Mobility Management Entity (MME)).

For example, in the LTE system, positioning is performed through position estimation based on downlink based on a time difference or positioning is performed through position estimation based on a cell ID. In the NR system, positioning may be performed by considering downlink-based position estimation (e.g., PRS) and uplink-based position estimation (eg, SRS for positioning). In addition, the positioning may perform a positioning operation based on a signal exchange time for a plurality of cells in a round trip time (RTT) or a positioning operation based on a cell ID. In addition, the positioning may perform a positioning operation based on a signal reception time difference. In addition, since communication is performed based on beams in the new communication system, a positioning operation can be performed based on an angle difference for each beam. Downlink/uplink reference signals and terminal/base station operations based on the foregoing may be shown in Tables 6 and 7 below.

TABLE 6

| | | To facilitate support |
|---|---|---|
| DL/UL Reference | UE | of the following |
| Signals | Measurements | positioning techniques |
| Release-16 DL PRS | DL RSTD | DL-TDOA |
| Release-16 DL PRS | DL PRS RSRP | DL-TDOA, |
| | | DL-AoD, |
| | | Multi-RTT |
| Release-16 DL PRS/ | UE Rx − Tx time | Multi-RTT |
| Release-16 SRS for | difference | |
| positioning | | |
| Release-15 SSB/ | SS-RSRP(RSRP for RRM), | E-CID |
| CSI-RS for RRM | SS-RSRQ(for RRM), | |
| | CSI-RSRP (for RRM), | |
| | CSI-RSRQ(for RRM), | |
| | SS-RSRPB(for RRM) | |

TABLE 7

| | | To facilitate support |
|---|---|---|
| DL/UL Reference | gNB | of the following |
| Signals | Measurements | positioning techniques |
| Release-16 SRS for | UL RTOA | UL-TDOA |
| positioning | | |
| Release-16 SRS for | UL SRS-RSRP | UL-TDOA, |
| positioning | | UL-AoA, |
| | | Multi-RTT |
| Release-16 SRS for | gNB Rx − Tx time | Multi-RTT |
| positioning, | difference | |
| Release-16 DL PRS | | |
| Release-16 SRS for | AoA and ZoA | UL-AoA, |
| positioning, | | Multi-RTT |

Here, the terms in Tables 6 and 7 may be as follows.
RSTD (reference signal time difference)
RSRP (reference signal received power)
RTOA (relative time of arrival)
RSRQ (reference signal received quality)
RSRPB (reference signal received power per branch)
RRM (Radio Resource Management)

Here, RSTD may be a transmission time difference of a reference signal, and RTOA may be a relative time value at which a signal arrives. Positioning may be performed based on location information of a transmission point by calculating a relative time difference value based on a location and a transmission time difference of a transmission point that has transmitted a reference signal. In addition, RSRP is the strength of the received reference signal, and RSRPB is the strength of the reference signal measured in each branch. RSRQ is the quality of the received reference signal. It is possible to check whether the positioning operation is possible by checking the strength and quality of the reference signal received through RSRP and RSRQ. RRM can also perform resource management and check resources for positioning.

Accordingly, positioning in the new communication system may be performed based on at least one of downlink/uplink, time difference/angle difference, RTT, and cell ID. Here, looking at the downlink PRS (DL PRS) for the positioning, a DL PRS resource set may be configured in one base station (or transmission reception point, TRP). In this case, the DL PRS resource set may be a set of DL PRS resources. Each DL PRS resource in the DL PRS resource set may have a respective DL PRS resource ID. For example, in a new communication system (e.g., NR), each base station (or TRP) may perform communication using a plurality of beams. In this case, each DL PRS resource ID may correspond to each beam transmitted from one base station (or TRP). That is, each DL PRS resource in the DL PRS resource set may correspond to each beam.

Here, the DL PRS configuration may include a DL PRS transmission schedule. In this case, the base station (or TRP) may instruct the terminal to configure the DL PRS. Accordingly, the UE may check the DL PRS based on the indicated DL PRS configuration without performing blind detection. Numerologies for DL PRS may be the same as numerologies for data transmission. For example, CP length and subcarrier spacing (SCS) for DL PRS may be the same as CP length and SCS for data transmission.

In addition, DL PRS resource sets in one or more base stations (or TRPs) may be transmitted through a positioning frequency layer. At this time, since the DL PRS resource sets are transmitted through the same positioning frequency layer, the SCS, CP type, center frequency, point A, bandwidth, and starting PRB (Physical Resource Block) and Comb size are set to the same. Here, the point A may be a value indicating the location of resource block 0 (RB 0). And, DL PRS resource sets may be transmitted through the same frequency layer. Here, the DL PRS sequence is a gold sequence and may be a binary sequence. This may be the same as the DL PRS of the existing system. The DL PRS sequence ID may be 4096. This may be more than the sequence 1024 for cell ID in NR. In addition, the DL PRS may be modulated based on Quadrature Phase Shift Keying (QPSK) and transmitted based on Cyclic-Prefix Orthogonal Frequency Division Multiplexing (CP-OFDM). In addition, as a time axis resource for DL PRS, it can be composed of 12 symbols within one slot, and a comb size of up to comb-12 can be supported.

More specific details may be shown in Table 8 below. That is, intervals at which PRSs are allocated in the frequency axis may be different based on the comb size. In the LTE system, DL PRS can be transmitted using all symbols within one slot. However, in the NR system, which is a new communication system, DL PRSs may be transmitted based on different number of symbols as shown in Table 8 below.

TABLE 8

| | 2 symbols | 4 symbols | 6 symbols | 12 symbols |
|---|---|---|---|---|
| Comb-2 | {0, 1} | {0, 1, 0, 1} | {0, 1, 0, 1, 0, 1} | {0, 1, 0, 1, 0, 1, 0, 1, 0, 1, 0, 1} |
| Comb-4 | NA | {0, 2, 1, 3} | NA | {0, 2, 1, 3, 0, 2, 1, 3, 0, 2, 1, 3} |
| Comb-6 | NA | NA | {0, 3, 1, 4, 2, 5} | {0, 3, 1, 4, 2, 5, 0, 3, 1, 4, 2, 5} |
| Comb-12 | NA | NA | NA | {0, 6, 3, 9, 1, 7, 4, 10, 2, 8, 5, 11} |

A PRS transmission period may be set for each PRS resource set. For example, each base station (or TRP) may configure a plurality of DL PRS resource sets. A plurality of DL PRS resource sets having different cycles may exist in the same base station (or TRP), and the cycles may be set in various ways.

Resources allocated for transmission of DL PRS (hereinafter referred to as DL PRS resources) may be repeated 1, 2, 4, 6, 8, 16 or 32 times. The interval between each repeated DL PRS resource may be set to one of 1, 2, 4, 8, 16 and 32 slots, but is not limited to the above-described embodiment.

Regarding frequency allocation for the DL PRS resource, the granularity of the DL PRS bandwidth may be 4 PRB. The starting PRB may be indicated to the UE as a parameter, and the UE may determine the starting PRB based on the indicated parameter. For example, the minimum bandwidth for DL PRS may be 24 PRBs and the maximum bandwidth may be 272 PRBs.

A resource element (RE) offset may be set in the frequency axis in relation to the DL PRS. In this case, the RE offset may be set to have a constant offset in the frequency axis based on the comb pattern with respect to the first symbol of the DL PRS resource. The first symbol may be configured in the terminal. After that, the remaining symbols may be determined based on the RE offset with respect to the first symbol.

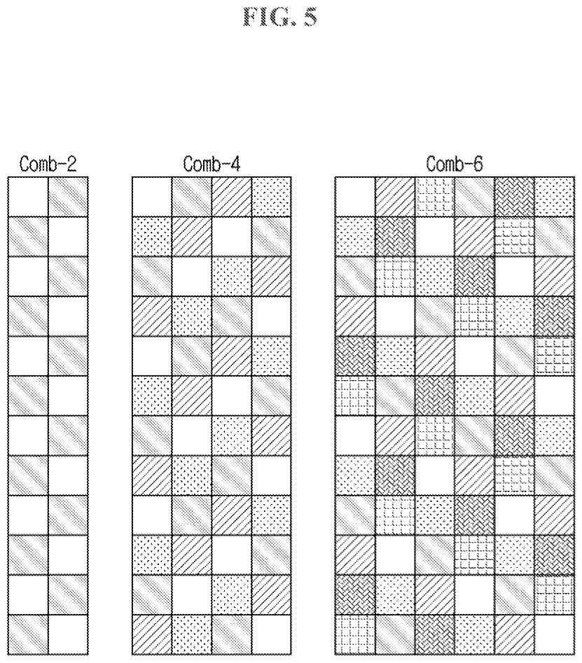

FIG. 5 is a diagram showing a comb pattern applicable to the present disclosure.

Referring to FIG. 5, a DL PRS RE pattern in the case where the comb size and the number of symbols are the same will be described as an example.

More specifically, a case where the comb size is 2 (Comb-2) and is allocated to two symbols (0, 1) may be considered. In this case, the RE offset may be {0,1}. That is, DL PRSs may be allocated to the first symbol and the second symbol according to the RE offset {0,1}, and the frequency axis may be allocated based on the comb size 2. As a case in which the comb size is 4 (Comb-4), a case in which four symbols (0, 1, 2, and 3) are allocated may be considered. In this case, the RE offset may be {0,2,1,3}. That is, DL PRSs from the first symbol to the fourth symbol may be allocated according to the RE offset {0,2,1,3}, and the frequency axis may be allocated based on the comb size 4. A case in which six symbols (0, 1, 2, 3, 4, and 5) are allocated can be considered as a case in which the comb size is 6 (Comb-6). In this case, the RE offset may be {0,3,1,4,2,5}. That is, DL PRSs from the first symbol to the sixth symbol may be allocated according to the RE offset {0,3,1,4,2,5}, and the frequency axis may be allocated based on the comb size 6.

In the present invention, DL PRS muting may be supported. When the UE is instructed to mute the DL PRS, the UE can mute the corresponding DL PRS. Here, a DL PRS muting bitmap for a DL PRS resource set may be configured, and based on this, a DL PRS to be muted may be indicated to the UE. In this case, each bit of the DL PRS muting bitmap (hereinafter, option 1 bitmap) may correspond to each occasion or consecutive instances in the DL PRS resource set. In this case, when a specific bit indicates muting, all DL PRSs in an occasion corresponding to the specific bit or consecutive instances may be muted.

In addition, a bitmap indicating muting (hereinafter, an option 2 bitmap) may indicate muting for each DL PRS resource within an occasion or instance for one period. Each bit of the bitmap may correspond to a repetition index of each DL PRS resource in an occasion or instance for one period, that is, each bit corresponds to one time of DL PRS within each one DL PRS period. may correspond to repetition of, and muting may be indicated by each bit. For example, a bitmap may be configured with any one of 2, 4, 8, 16, or 32 bits.

Regarding the muting option, at least one of an option 1 bitmap and an option 2 bitmap may be configured in the terminal. For example, only option 1 bitmap may be configured in terminal 1. Also, as an example, only the option 2 bitmap may be configured in terminal 2. Also, as an example, both option 1 bitmap and option 2 bitmap may be configured in terminal 3. At this time, when both the option 1 bitmap and the option 2 bitmap are configured in terminal 3, all DL PRS resources in the location for which muting is instructed based on option 1 are muted, and muting is not instructed by the option 1 bitmap. Among the occasions, DL PRS resources for which muting is indicated by the option 2 bitmap may be muted.

In a new communication system (e.g., NR), a DL PRS can be created and positioning can be performed. In this case, referring to Table 8 described above, there may be 12 fully orthogonal resources within one slot. In this case, when the comb size is 2 (comb-2) and the DL PRS is allocated to two symbols, there are two orthogonal resources, and six can be additionally distinguished based on a symbol offset. In addition, when the comb size is 4 (comb-4) and the DL PRS is allocated to two symbols, there are four orthogonal resources, and three can be additionally distinguished based on a symbol offset. In addition, when the comb size is 6 (comb-6) and DL PRS is allocated to six symbols, there are six orthogonal resources, and two can be additionally distinguished based on a symbol offset. In addition, when the comb size is 12 (comb-12) and DL PRSs are allocated to twelve symbols, there are twelve orthogonal resources, and only one can be distinguished based on a symbol offset.

Regarding the DL PRS, in a new communication system, up to 64 TRPs can be supported in one frequency layer, and 64 resources can be allocated for each TRP. Considering this, the DL PRS ID may be 4096 (64*64).

As an example, when the terminal operates based on an IIOT scenario in a 120 kHz band, 18 TRPs may be supported considering the scenarios in Table 5 described above. In this case, each of 64 resources may be supported for DL PRS considering that 64 beams are supported per TRP. Accordingly, the total required resources may be 1152 (18*64). Here, a fully orthogonal resource within one slot is 12 symbols. Considering 1152 resources, 96 (1152/12=96) slots may be required. In this case, 96 slots may correspond to 12 ms at 120 Khz.

Meanwhile, positioning-related delay requirements may be set to 100 ms. Considering these IIOT scenarios, delay requirements can be set to 10 ms, 20 ms or less than 100 ms. Therefore, if the slots (96 slots) corresponding to 12 ms are used, the delay requirement (10 ms) may not be satisfied. That is, a method of efficiently allocating DL PRS resources may be required. Therefore, the present invention proposes a method of allocating DL PRSs to fewer slots by increasing orthogonality, which can avoid collisions between TRPs in consideration of the requirements considering the IIoT scenario, and also through muting We propose a PRS resource allocation method that satisfies newly proposed requirements by using a method of reducing overhead.

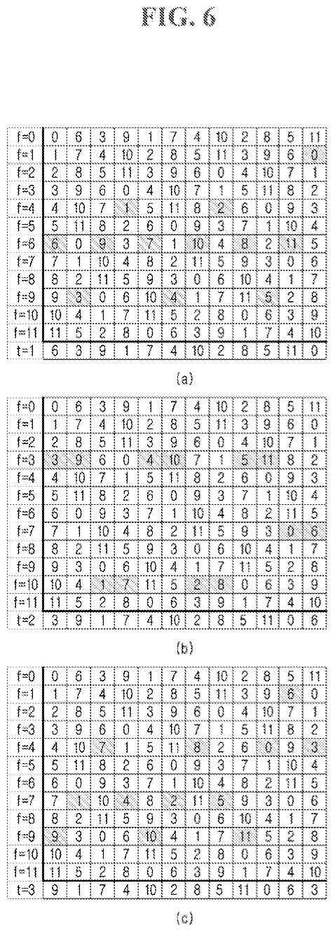

FIG. 6 to FIG. 8 are diagrams illustrating a method of increasing orthogonality for DL PRS resource allocation applicable to the present disclosure. Hereinafter, a communication system to which the present invention is applied may apply a method of increasing orthogonality in a DL PRS allocation pattern for satisfying delay requirements for positioning operations in consideration of IIOT scenarios and use cases.

FIG. 6 is a diagram illustrating a DL PRS pattern of comb size 12 applicable to the present disclosure.

Referring to FIG. 6, in the case of a comb size of 12, DL PRSs may be allocated to 12 symbols. This can refer to Table 8. Here, the pattern to which the DL PRS is allocated may be {0,6,3,9,1,7,4,10,2,8,5,11}.

Specifically, referring to (a) of FIG. 6, f=y is a case where the frequency axis is cyclically shifted by y, and there is no shift in the time axis (ie, t=0). For example, when f=0, there is no transposition in the frequency axis and no transposition in the time axis, so the DL PRS allocation pattern is {0,6,3,9,1,7,4,10,2,8,5,11}. In addition, as an example, when f=1, the frequency axis is transposed by 1, and the time axis is not transposed, so the pattern is {1,7,4,10,2,8,5,11,3,9,6,0}. Also, as an example, when f=y, it may be a case where the frequency axis is transposed by y, and the time axis is not transposed. In addition, when t=x, it is a case in which cyclic transposition is performed by x in the time axis, and may be a case in which the transposition is not performed in the frequency axis. For example, when t=1, since the time axis is transposed by 1 and the frequency axis is not transposed, the DL PRS pattern is {6,3,9,1,7,4,10,2,8,5,11,0}. Here, as an example, if the orthogonality of each resource can be maintained after cyclic prefix is performed on the frequency axis or the time axis, since the orthogonality is increased based on the cyclic prefix, more PRS resources can be allocated.

Referring to (a) of FIG. 6, when cyclic prefix is performed only in the frequency axis, orthogonality for each resource can be maintained. That is, orthogonality can be maintained even when any two resources from f=0 to f=11 are selected. On the other hand, the case of t=1 may be considered as a case in which the time axis cyclic prefix is also considered. Here, orthogonality may not be guaranteed because each resource in the case where cyclic prefix is performed as much as f=6 or when cyclic prefix is performed as much as f=9 collides with the case where t=1.

Referring to (b) of FIG. 6, the case of t=2 may be considered as a case in which the time axis cyclic prefix is also considered. Here, if cyclic prefix is performed as much as f=3, if cyclic prefix is performed as much as f=7, and if cyclic prefix is performed as much as f=10, resources collide with the case of t=2, so orthogonality is not guaranteed.

Referring to (c) of FIG. 6, a case of t=3 may be considered as a case in which the time axis cyclic prefix is also considered. Here, orthogonality is not guaranteed because resources in the case where cyclic prefix is performed as much as f=4, when cyclic prefix is performed as much as f=7, and when cyclic prefix is performed as much as f=9 collide with the case of t=3.

According to the DL PRS allocation pattern {0,6,3,9,1,7,4,10,2,8,5,11}, when both the frequency axis cyclic prefix and the time axis cyclic prefix are considered, collision Since orthogonality cannot be maintained, it may not be possible to increase the pattern based on this.

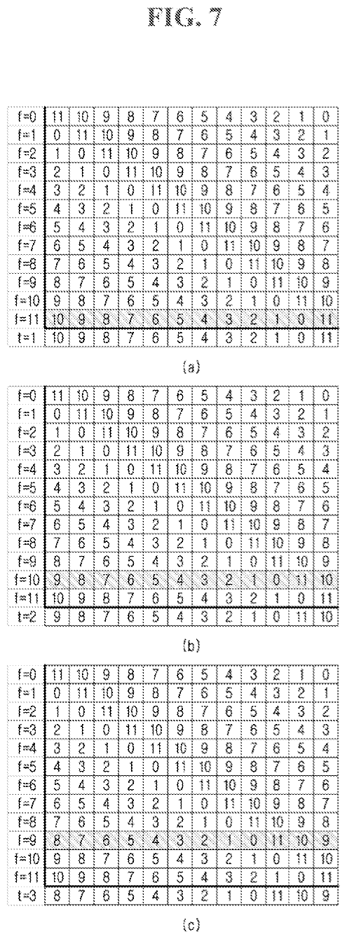

FIG. 7 is a diagram illustrating a case where a DL PRS pattern of comb size 12 applicable to the present disclosure is a diagonal pattern.

Referring to FIG. 7, in the case of a comb size of 12, DL PRSs may be allocated to 12 symbols. Here, the pattern to which the DL PRS is allocated may be {11, 10, 9, 8, 7, 6, 5, 4, 3, 2, 1, 0}. Here, f=y is a case in which a cyclic shift is performed by y in the frequency axis, and may be a case in which there is no shift in the time axis (ie, t=0). For example, when f=0, there is no transposition in the frequency axis and no transposition in the time axis, so the DL PRS allocation pattern is {11, 10,9,8,7,6,5,4,3,2,1,0}. In addition, as an example, when f=1, the frequency axis is transposed by 1, and the time axis is not transposed, so the pattern is {0,11,10,9,8,7,6,5, 4,3,2, 1}. Also, as an example, when f-y, it may be a case where the frequency axis is transposed by y, and the time axis is not transposed. In addition, when t=x, it is a case in which cyclic transposition is performed by x in the time axis, and may be a case in which the transposition is not performed in the frequency axis. Here, a diagonal pattern may be formed based on the frequency axis cyclic prefix. In addition, as an example, when t=1, the time axis is transposed by 1 and the frequency axis is not transposed, so the DL PRS pattern is {10,9,8,7,6,5,4,3,2, 1,0,11}. Here, if orthogonality of each resource can be maintained after cyclic prefix is performed on the frequency axis or the time axis, orthogonality can be increased based on cyclic prefix.

Referring to (a) of FIG. 7, when cyclic prefix is performed only in the frequency axis, orthogonality for each resource can be maintained. That is, orthogonality can be maintained even when any two resources from f=0 to f=11 are selected. On the other hand, the case of t=1 may be considered as a case in which the time axis cyclic prefix is also considered. Here, since all resources in the case where cyclic prefix is performed as much as f=11 may collide with the case where t=1, orthogonality may not be guaranteed.

Referring to (b) of FIG. 7, the case of t=2 may be considered as a case in which the time axis cyclic prefix is also considered. Here, all resources in the case where cyclic prefix is performed by f=10 may collide with the case in which t=1. Also, referring to (c) of FIG. 7, the case of t=3 may be considered as a case in which the time axis cyclic prefix is also considered. Here, all resources in the case where cyclic prefix is performed by f=9 may collide with the case in which t=1. That is, according to the diagonal pattern (or existing system pattern) {11,10,9,8,7,6,5,4,3,2, 1,0}, considering both the frequency axis cyclic prefix and the time axis cyclic prefix In this case, since orthogonality cannot be maintained due to collision, the pattern may not be increased based on this.

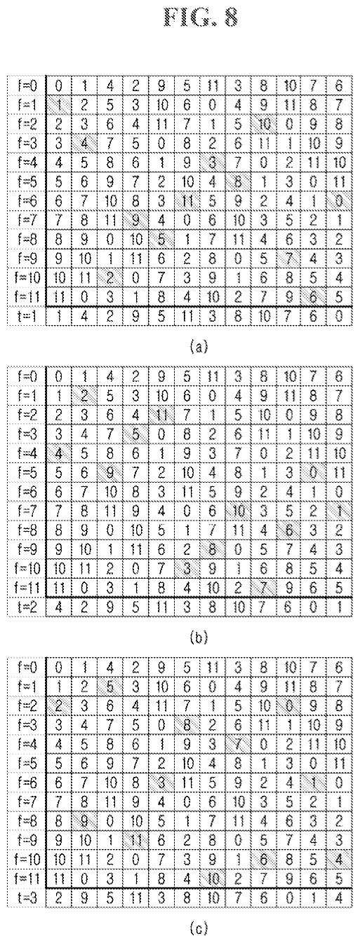

FIG. 8 is a diagram illustrating a pattern maintaining orthogonality after cyclic prefix in a DL PRS pattern of comb size 12 applicable to the present disclosure.

Referring to FIG. 8, if orthogonality is maintained even after the frequency axis cyclic prefix and the time axis cyclic prefix are performed, orthogonality can be increased, and through this, each DL PRS can be distinguished. For example, in the case of a comb size of 12 and using 12 symbols, the DL PRS allocation pattern maintaining orthogonality even after cyclic prefix is {0, 1,4,2,9,5,11,3,8, 10,7,6}. Also, as an example, in the case of a comb size of 6 and in the case of using 6 symbols, the DL PRS allocation pattern maintaining orthogonality even after cyclic prefix may be {0,2, 1,4,5,3}. As a specific example, the above-described pattern may be derived when Equation 3 below is satisfied based on the “Costas Array by Logarithmic Welch method”. Here, P may be a prime number, and Equation 3 may be a method for a pattern that avoids collisions as an array function.

$$Costas Array by Logarithmic Welch method : ( P - 1 ) * ( P - 1 ) \qquad [ Equation 3 ]$$

Let a be the primitive element in the modular operation for prime p, then f: {1, 2, . . . , p−1}→{1, 2, . . . , p−1} (defined by f(i)=logₐi) may be a (P−1)*(P−1) modular sonar sequence.

Based on Equation 3 above, as the case where P is a prime number, cases of 12*12, 6*6, and 4*4 may be considered. Based on Equation 3 above, when the comb size is 12, the DL PRS allocation pattern can be derived as {0,1,4,2,9,5,11,3,8,10,7,6}. Also, in the case of a comb size of 6, the DL PRS allocation pattern may be derived as {0,2, 1,4,5,3}. A pattern for the case of the comb size of 12 may be as shown in FIG. 8.

Specifically, referring to (a) of FIG. 8, the pattern to which DL PRS is allocated is {0, 1,4,2,9,5,11,3,8, 10,7,6 based on Equation 3}. Here, f=y is a case in which a cyclic shift is performed by y in the frequency axis, and may be a case in which there is no shift in the time axis (ie, t=0). For example, when f=0, there is no transposition in the frequency axis and no transposition in the time axis, so the DL PRS allocation pattern is {0,1,4,2,9,5,11,3,8,10,7,6}. In addition, when f=1, the frequency axis is transposed by 1, and the time axis is not transposed, so the pattern is {1,2,5,3, 10,6, 12,4,9, 11,8,7}. In addition, in the case of f-y, it may be a case in which the frequency axis is transposed by y, and the transposition in the time axis is not performed. In addition, when t=x, it is a case in which cyclic transposition is performed by x in the time axis, and may be a case in which the transposition is not performed in the frequency axis.

In addition, when t=1, since it is transposed by 1 on the time axis and not transposed on the frequency axis, the DL PRS pattern is {1,4,2,9,5,11,3,8, 10,7,6,0}. Here, if orthogonality of each resource can be maintained after cyclic prefix is performed on the frequency axis or the time axis, orthogonality can be increased based on cyclic prefix.

Referring to (a) of FIG. 8, when cyclic prefix is performed only in the frequency axis, orthogonality for each resource can be maintained. That is, orthogonality can be maintained even when any two resources from f=0 to f=11 are selected. In addition, the case of t=1 may be considered as a case in which the time axis cyclic prefix is also considered. Here, orthogonality can be maintained even when any two resources from f=0 to f=11 are selected. However, as an example, when f=6, some resources (two) may collide, but the number of collisions may be small, so performance degradation may be small.

Also, referring to (b) of FIG. 8, the case of t=2 may be considered as a case in which the time axis cyclic prefix is also considered. Here, orthogonality can be maintained even when any two resources from f=0 to f=11 are selected. However, as an example, when f=5 or f=7, some resources (two) may collide, but performance degradation may be small because the number of collisions is not large. Also, referring to FIG. 8(c), a case of t=3 may be considered as a case in which time axis cyclic prefix is also considered. Here, orthogonality can be maintained even when any two resources from f=0 to f=11 are selected. However, as an example, when f=2 or f=10, some resources (two) may collide, but the number of collisions may be small and performance degradation may be small.

When the DL PRS allocation pattern for the comb size 12 is determined based on Equation 3, an orthogonal pattern or a similar orthogonal pattern can be secured based on the frequency axis cyclic prefix and the time axis cyclic prefix, thereby increasing orthogonality can make it.

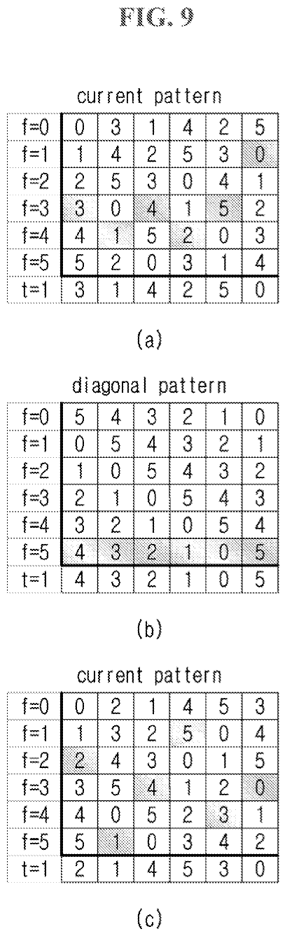

FIG. 9 is a diagram illustrating a DL PRS pattern of comb size 6 applicable to the present disclosure. The DL PRS pattern according to the present invention can be equally applied to the comb size 6.

Referring to (a) of FIG. 9, it may be a method of allocating a DL PRS based on {0,3,1,4,2,5} as a DL PRS pattern. Here, when frequency-axis cyclic prefix and time-axis cyclic prefix are performed, orthogonality may not be maintained because a collision occurs when f=3, f=4, and t=1.

Referring to (b) of FIG. 9 may be a method of allocating DL PRSs to diagonal patterns {5,4,3,2,1,0}. Here, when frequency-axis cyclic prefix and time-axis cyclic prefix are performed, orthogonality may not be maintained because a collision occurs when f=5 and all resources when t=1.

Referring to (c) of FIG. 9 may be a pattern {0,2, 1,4,5,3} for maintaining an orthogonal pattern after cyclic prefix based on Equation 3 above. Here, when frequency axis cyclic prefix and time axis cyclic prefix are performed, orthogonality can be maintained even if any two resources of f=0 to f=5 are selected. However, as an example, when f=3, some resources (two) may collide, but performance degradation may be small because the number of collisions is not large.

According to the present invention, when the DL PRS allocation pattern for the comb size 6 is determined based on Equation 3, an orthogonal pattern or a similar orthogonal pattern can be secured based on the frequency axis cyclic prefix and the time axis cyclic prefix. Orthogonality can be increased through

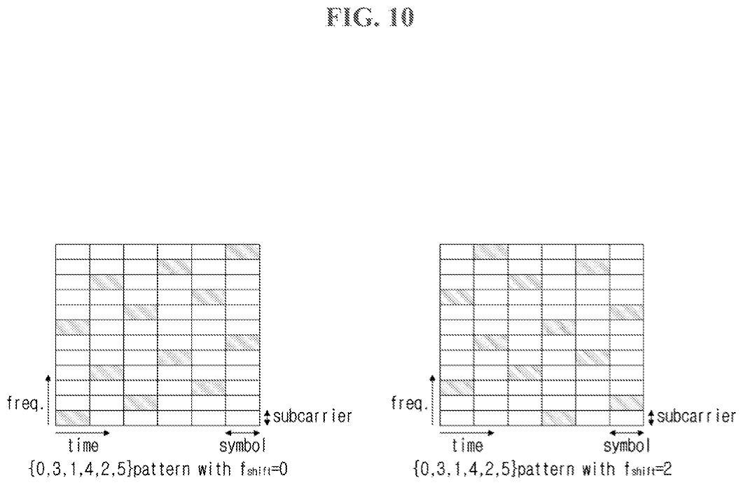

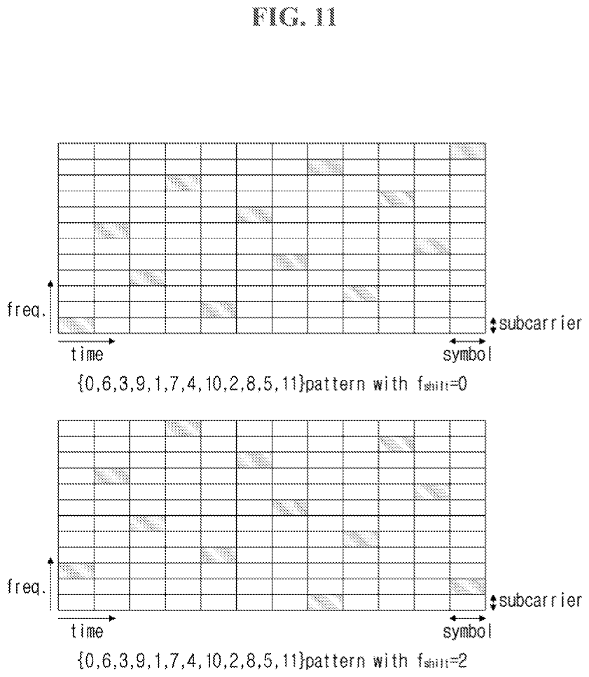

FIG. 10 and FIG. 11 are diagrams illustrating a method of performing cyclic prefix based on a DL PRS allocation pattern applicable to the present disclosure. Orthogonality of the DL PRS allocation pattern may be broken due to collision when both the frequency axis cyclic prefix and the time axis cyclic prefix are performed. Accordingly, when performing cyclic prefix based on the DL PRS allocation pattern, only frequency axis cyclic prefix may be possible.

Referring to FIG. 10, in the case of a comb size of 6, as a pattern in which DL PRSs are allocated to 6 symbols, in the case of {0,3, 1,4,2,5}, 6 patterns may be possible with frequency axis cyclic prefix, 10 may be a resource allocation method in the case of f=0 and in the case of f=2.

Referring to FIG. 11, in the case of a comb size of 12, when DL PRS patterns of {0,6,3,9,1,7,4,10,2,8,5,11} are allocated to 12 symbols Twelve patterns may be possible with frequency axis cyclic prefix, and FIG. 11 may be a resource allocation method in the case of f=0 and f=2.

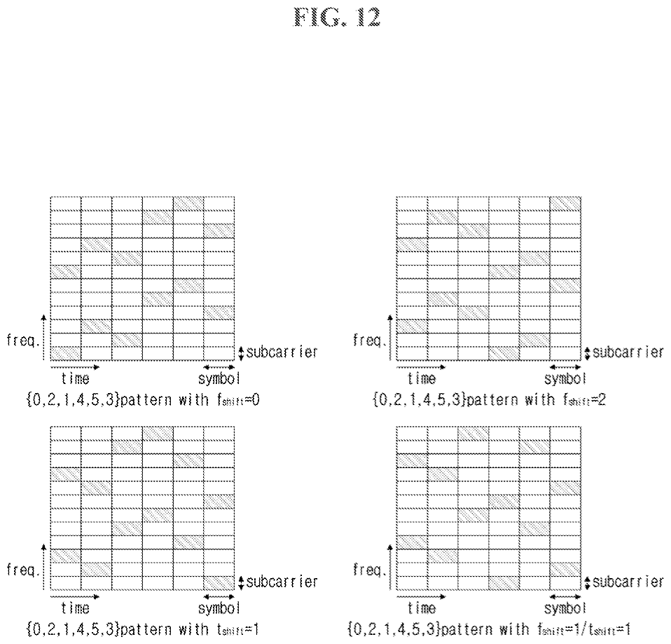

FIG. 12 to FIG. 14 are diagrams illustrating a method of performing cyclic prefix based on a DL PRS allocation pattern in which orthogonality is maintained even after cyclic prefix applicable to the present disclosure.

When the DL PRS allocation pattern is determined based on Equation 3, orthogonality can be maintained even if both the frequency axis cyclic prefix and the time axis cyclic prefix are performed. This can satisfy performance requirements even if some orthogonality is broken. Here, when cyclic prefix is performed based on the DL PRS allocation pattern based on Equation 3, frequency axis cyclic prefix may be possible. In addition, when cyclic prefix is performed, both frequency axis cyclic prefix and time axis cyclic prefix may be possible.

Referring to FIG. 12, as a pattern in which DL PRS is allocated to 6 symbols in the case of a comb size of 6, in the case of {0,2, 1,4,5,3} based on Equation 3, the frequency axis cyclic prefix Six patterns may be possible. In addition, in the case of a comb size of 6, in the case of {0,2, 1,4,5,3} based on Equation 3 as a pattern in which DL PRS is allocated to 6 symbols, frequency axis cyclic prefix and time axis cycle Based on the transposition, 36 patterns are possible. That is, orthogonality may increase. In this case, as described above, since orthogonality increases, each DL PRS resource may be distinguished.

Here, the PRS resource ID may correspond to each DL PRS resource. The PRS resource ID may have different frequency axis shift values and time axis shift values based on the above-described DL PRS pattern. As another example, the frequency axis shift value and the time axis shift value may be different according to the PRS sequence ID, and through this, the DL PRS can be distinguished. A frequency axis shift value may be set differently according to the PRS resource ID. Additionally, a time axis shift value may be set differently according to the PRS resource set ID. In addition, the frequency axis shift value may be set differently according to the PRS resource ID. Additionally, a time axis shift value may be set differently according to the PRS sequence ID.

As an example, FIG. 12 is based on the above-described DL PRS pattern {0,2, 1,4,5,3} when f=0, when f=2, when t=1, and f=1/t=1, and orthogonality can be maintained in each case.

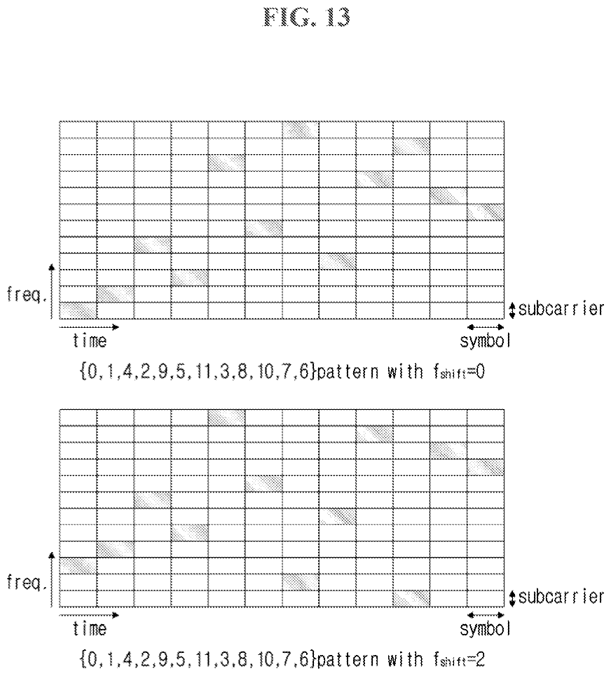

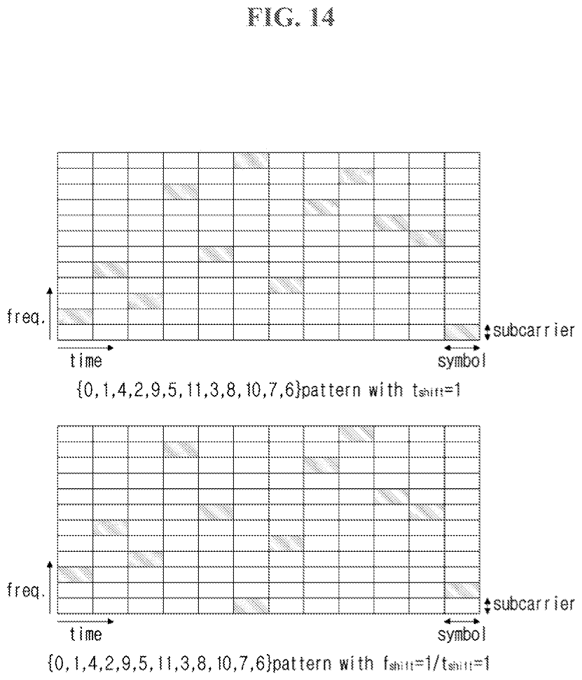

As another example, referring to FIGS. 13 and 14, based on Equation 3 as a pattern in which DL PRSs are allocated to 12 symbols in the case of a comb size of 12, {0,6,3,9,1,7,4,10,2,8,5,11}, 12 patterns may be possible with frequency axis cyclic prefix. For example, in the case of a comb size of 12, a pattern in which DL PRSs are allocated to 12 symbols is {0,6,3,9,1,7,4,10,2,8,5,11 based on Equation 3}, 144 patterns may be possible based on the frequency axis cyclic prefix and the time axis cyclic prefix. That is, orthogonality may increase. At this time, since orthogonality increases, it may be possible to distinguish each DL PRS resource.

The PRS resource ID may correspond to each DL PRS resource. In this case, the PRS resource ID may have different frequency axis shift values and time axis shift values based on the above-described DL PRS pattern. As another example, the frequency axis shift value and the time axis shift value may be different according to the PRS sequence ID, and through this, the DL PRS can be distinguished. In addition, the frequency axis shift value may be set differently according to the PRS resource ID. Additionally, a time axis shift value may be set differently according to the PRS resource set ID. In addition, the frequency axis shift value may be set differently according to the PRS resource ID. Additionally, a time axis shift value may be set differently according to the PRS sequence ID.

FIG. 13 may be the case of f=0 and f=2 based on the DL PRS pattern {0,6,3,9,1,7,4,10,2,8,5,11}. FIG. 14 is based on the DL PRS pattern {0,6,3,9,1,7,4,10,2,8,5,11} when t=1 and when f=1/t=1 can

Next, a method for reducing overhead is proposed. For example, a new muting pattern for preventing collision between a plurality of TRPs may be considered.

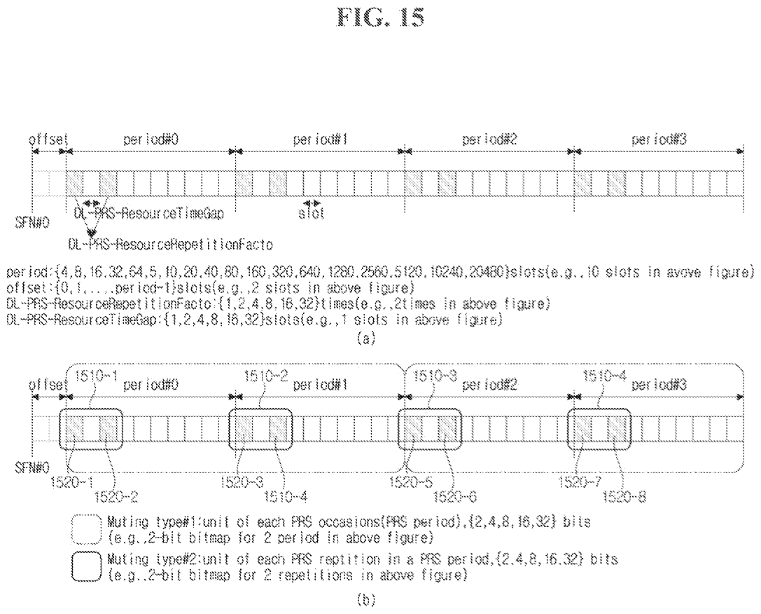

FIG. 15 is a diagram illustrating a DL PRS resource allocation method applicable to the present disclosure.

In the communication system according to the present invention, DL PRS muting may be supported. When the UE is instructed to mute the DL PRS, the UE can mute the corresponding DL PRS. Here, a DL PRS muting bitmap for a DL PRS resource set may be configured, and based on this, a DL PRS to be muted may be indicated to the UE. In this case, each bit of the DL PRS muting bitmap (hereinafter, option 1 bitmap) may correspond to each occasion or consecutive instances in the DL PRS resource set. Here, each DL PRS occasion may correspond to all DL PRS resources (including repetitive transmission) within each DL PRS period. That is, one DL PRS occasion may correspond to one DL PRS cycle.

In this case, when a specific bit indicates muting, all DL PRSs in an occasion corresponding to the specific bit or consecutive instances may be muted. As an example, the DL PRS of the legacy system (LTE) may also be muted on an occasion basis as described above. As another example, a bitmap indicating muting (hereinafter, option 2 bitmap) may indicate muting for each DL PRS resource within an occasion or instance for one period. Here, each bit of the bitmap may correspond to a repetition index of each DL PRS resource in an occasion or instance for one period (ie, each bit corresponds to a DL PRS within each one DL PRS period). Corresponding to one repetition of), muting may be indicated by each bit. In this case, the bitmap may be configured with any one of 2, 4, 8, 16 or 32 bits.

For example, in relation to the muting option, at least one of an option 1 bitmap and an option 2 bitmap may be configured in the terminal. For example, only option 1 bitmap may be configured in terminal 1. In addition, only the option 2 bitmap can be configured in terminal 2. For example, both option 1 bitmap and option 2 bitmap may be configured in terminal 3. In this case, when both the option 1 bitmap and the option 2 bitmap are configured in the terminal, all DL PRS resources in the muting-instructed occasion based on option 1 are muted, and the option 2 bitmap among the muting-instructed occasions DL PRS resources for which muting is indicated by may be muted.

Referring to (a) of FIG. 15, the UE can check the DL PRS period and offset indicated based on the DL PRS configuration. In (a) of FIG. 15, the period is set to 10 slots and the offset is set to 2 slots, but this is only an example and is not limited to the above-described embodiment. In addition, the UE can check the repetition pattern of the DL PRS resource within a period through “DL-PRS-ResourceRepetitionFactor” indicated based on the DL PRS configuration. In addition, “DL-PRS-ResourceRepetitionFactor” is set to indicate repetition twice, but this is only an example and is not limited to the above-described embodiment. The UE can check the time interval between DL PRS resources within one cycle through “DL-PRS-ResourceTimeGap” indicated based on the DL PRS configuration. For example, in (a) of FIG. 15, “DL-PRS-ResourceTimeGap” is set to one slot, but this is only an example and is not limited to the above-described embodiment.

Referring to (b) of FIG. 15, the terminal may perform muting based on the option 1 bitmap. For example, the option 1 bitmap may be a 2-bit muting bitmap for two periods, and each bit corresponds to one occasion corresponding to one period. In this case, muting for a corresponding occasion may be performed based on each bit. Also, as an example, the option 2 bitmap is 2 bits, and repetition of each DL PRS within one period may correspond to each bit.

When muting is instructed to the terminal based on the option 1 bitmap, all DL PRSs of the corresponding occasion may be muted. On the other hand, in the case of the option 2 bitmap, among occasions in which muting is not instructed to the terminal based on the option 1 bitmap, a DL PRS for which muting is instructed through the option 2 bitmap may be muted. That is, of the DL PRS, only the DL PRS resource indicated that neither the option 1 bitmap nor the option 2 bitmap is muted can be used. As a specific embodiment, each of the DL PRS locations 1510-1, 1510-2, 1510-3, and 1510-4 in (b) of FIG. 15 may correspond to each PRS period. Here, the first DL PRS occasion (1510-1) is in “period #0”, the second DL PRS occasion (1510-2) is in “period #1”, and the third DL PRS occasion (1510-3) may correspond to “period #2” and the fourth DL PRS occasion 1510-4 may correspond to “period #3”.

Since each bit of the Option 1 bitmap corresponds to a DL PRS occasion, the Option 1 bitmap may be 2 bits. Here, among the 2-bit Option 1 bitmaps corresponding to the first DL PRS occasion 1510-1 and the second DL PRS occasion 1510-2, the first DL PRS occasion 1510-1 corresponds to If the bit indicates muting, all DL PRS resources 1520-1 and 1520-2 in the first DL PRS location 1510-1 are muted. In addition, if a bit corresponding to the second DL PRS occasion 1510-2 of the 2-bit option 1 bitmap indicates muting, the DL PRS resource 1520-3 within the second DL PRS occasion 1510-2, 1520-4) are all muted.

Meanwhile, among the 2-bit Option 1 bitmaps corresponding to the third DL PRS occasion 1510-3 and the fourth DL PRS occasion 1510-4, the third DL PRS occasion 1510-3 corresponds to If the bit indicates muting, all DL PRS resources 1520-5 and 1520-6 in the third DL PRS location 1510-3 are muted. In addition, if a bit corresponding to the fourth DL PRS occasion 1510-4 of the 2-bit Option 1 bitmap indicates muting, the DL PRS resource 1520-7 within the fourth DL PRS occasion 1510-4, 1520-8) are all muted.

Also, repetitions of DL PRS resources may be included in each of the DL PRS occasions 1510-1, 1510-2, 1510-3, and 1510-4. For example, the first DL PRS occasion 1510-1 includes two repetitions 1520-1 and 1520-2 of the DL PRS resource. The second DL PRS occasion 1510-2 also includes two repetitions 1520-3 and 1520-4 of the DL PRS resource. The third DL PRS occasion 1510-3 also includes two repetitions 1520-5 and 1520-6 of the DL PRS resource, and the fourth DL PRS occasion 1510-4 also includes two repetitions of the DL PRS resource. Includes iterations 1520-7 and 1520-8.

In this case, each bit of the option 2 bitmap may correspond to repetition of each DL PRS resource. Accordingly, the option 2 bitmap in the first DL PRS occasion 1510-1 is composed of 2 bits by two repetitions 1520-1 and 1520-2 of the DL PRS resource.

Here, when the option 1 bitmap indicates that the first DL PRS occasion 1510-1 is muted, the two repetitions 1520-1 and 1520-2 of the DL PRS resource are muted regardless of the option 2 bitmap. do. On the other hand, if the option 1 bitmap indicates that the first DL PRS occasion 1510-1 is not muted, the two repetitions 1520-1 and 1520-2 of the DL PRS resource are performed by the option 2 bitmap. Muting is indicated. Here, if a bit corresponding to the first iteration 1520-1 of the DL PRS resource in the 2-bit option 2 bitmap indicates muting, the corresponding DL PRS resource 1520-1 is muted. In addition, if a bit corresponding to the second iteration 1520-2 of the DL PRS resource in the 2-bit option 2 bitmap indicates muting, the corresponding DL PRS resource 1520-2 is muted. Option 2 bitmap may be applied when option 1 bitmap indicates not to be muted.

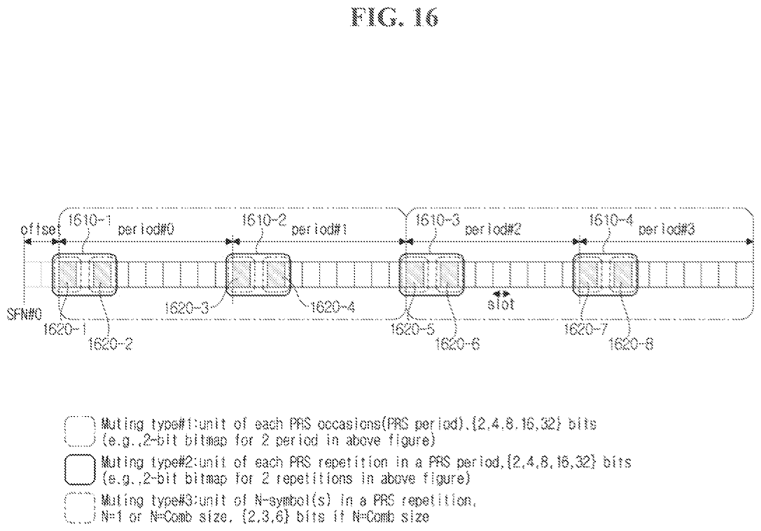

Referring to FIG. 16, a bitmap for instructing muting in units of N symbols (hereinafter, an option 3 bitmap) is configured to reduce delay of resource repetition together with an option 1 bitmap and an option 2 bitmap. can For example, an option 3 bitmap may be applied based on a comb size unit. That is, N may be equal to the comb size.

In FIG. 16, each of the DL PRS resources 1620-1, 1620-2, 1620-3, 1620-4, 1620-5, 1620-6, 1620-7, and 1620-8 consists of L DL PRS symbols. Here, L may be 2, 4, 6 or 12 as shown in Table 8.

As shown in FIG. 16, each DL PRS is configured within one slot, and as mentioned, one DL PRS is configured with L DL PRS symbols within one slot.

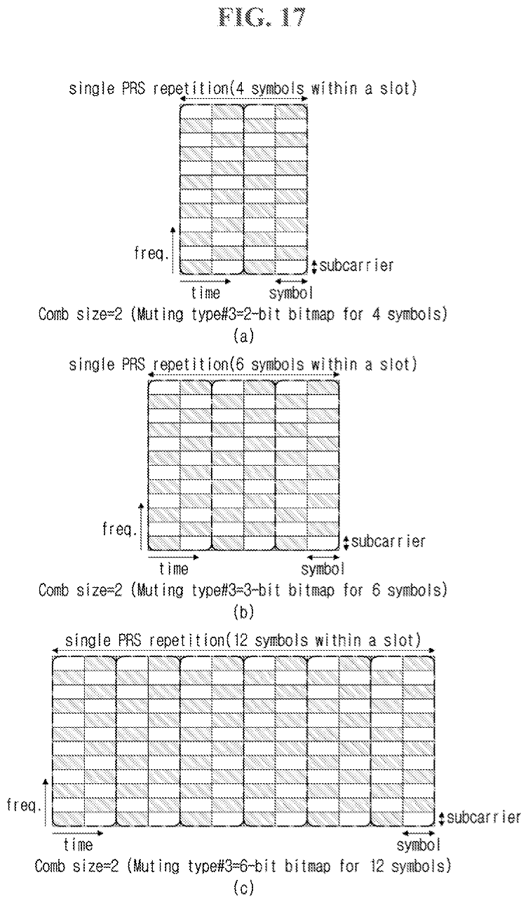

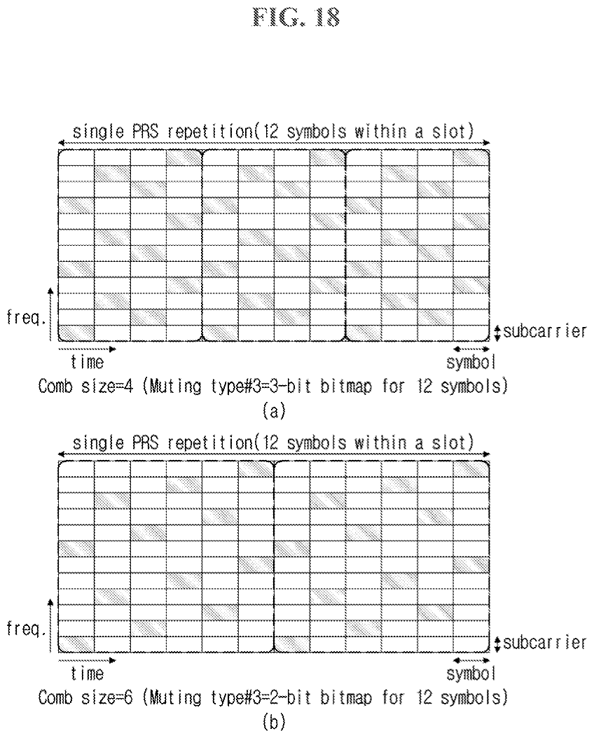

Additionally, the L symbols may consist of A repetitions of the N symbols. Here, N may be 1 or the comb size. For example, FIG. 17(a) corresponds to A=2 when Nis the comb size 2 (N=2), and FIG. 17(b) corresponds to the case where N is the comb size 2 (N=2) and A=3, and FIG. 17(c) corresponds to A=6 when N is the comb size 2 (N=2). In addition, FIG. 18(a) corresponds to A=3 when N is the comb size 4 (N=4), and FIG. 18(b) corresponds to the case where N is the comb size 6 (N=6) and A=2 applies to.

Here, the first repetition 1620-1 of the DL PRS resource in the DL PRS occasion 1610-1 in FIG. 16 is A repetition of N symbols within one slot, as shown in FIGS. 17 and 18. The second repetition 1620-2 of the DL PRS resource of the DL PRS occasion 1610-1 in FIG. 16 is also repeated A times of N symbols in one slot, as shown in FIGS. 17 and 18.

Each of the DL PRS resources 1620-3, 1620-4, and 1620- in the DL PRS location 1610-2, DL PRS location 1610-3, and DL PRS location 1610-4 in FIG. 5, 1620-6, 1620-7, 1620-8) may also consist of repeating A times of N symbols within one slot, as shown in FIGS. 17 and 18.

In this case, each bit of the option 3 bitmap may correspond to each repetition of N symbols A times. That is, bits may correspond to each N number of symbols in one slot. Thus, within each DL PRS resource (1620-1, 1620-2, 1620-3, 1620-4, 1620-5, 1620-6, 1620-7, 1620-8) the option 3 bitmap is N symbols It is composed of A bits by repetition of A number of times.

As a specific embodiment, each of the DL PRS occasions 1610-1, 1610-2, 1610-3, and 1610-4 may correspond to each PRS period. Here, the first DL PRS occasion (1610-1) is in “period #0”, the second DL PRS occasion (1610-2) is in “period #1”, and the third DL PRS occasion (1610-3) may correspond to “period #2” and the fourth DL PRS occasion 1610-4 may correspond to “period #3”.

Since each bit of the Option 1 bitmap corresponds to a DL PRS occasion, the Option 1 bitmap may be 2 bits. Here, among the 2-bit Option 1 bitmaps corresponding to the first DL PRS occasion 1610-1 and the second DL PRS occasion 1610-2, the first DL PRS occasion 1610-1 corresponds to If the bit indicates muting, all of the DL PRS resources 1620-1 and 1620-2 in the first DL PRS location 1610-1 are muted. In addition, if a bit corresponding to the second DL PRS occasion 1610-2 of the 2-bit Option 1 bitmap indicates muting, the DL PRS resource 1620-3 within the second DL PRS occasion 1610-2, 1620-4) are all muted.

Meanwhile, among the 2-bit option 1 bitmaps corresponding to the third DL PRS occasion 1610-3 and the fourth DL PRS occasion 1610-4, the third DL PRS occasion 1610-3 corresponds to If the bit indicates muting, all DL PRS resources 1620-5 and 1620-6 in the third DL PRS occasion 1610-3 are muted. In addition, if a bit corresponding to the fourth DL PRS occasion 1610-4 of the 2-bit option 1 bitmap indicates muting, the DL PRS resource 1620-7 in the fourth DL PRS occasion 1610-4, 1620-8) are all muted.

Also, repetitions of DL PRS resources may be included in each of the DL PRS occasions 1610-1, 1610-2, 1610-3, and 1610-4. For example, the first DL PRS occasion 1610-1 includes two repetitions 1620-1 and 1620-2 of the DL PRS resource. The second DL PRS occasion 1610-2 also includes two repetitions 1620-3 and 1620-4 of the DL PRS resource. The third DL PRS occasion 1610-3 also includes two repetitions 1620-5 and 1620-6 of the DL PRS resource, and the fourth DL PRS occasion 1610-4 also includes two repetitions of the DL PRS resource. Includes iterations 1620-7 and 1620-8.

In this case, each bit of the option 2 bitmap may correspond to repetition of each DL PRS resource. Accordingly, the option 2 bitmap in the first DL PRS occasion 1610-1 is composed of 2 bits by two repetitions 1620-1 and 1620-2 of the DL PRS resource.

Here, when the option 1 bitmap indicates that the first DL PRS occasion 1610-1 is muted, the two repetitions 1620-1 and 1620-2 of the DL PRS resource are muted regardless of the option 2 bitmap. do. On the other hand, if the option 1 bitmap indicates that the first DL PRS occasion 1610-1 is not muted, the two repetitions 1620-1 and 1620-2 of the DL PRS resource are performed by the option 2 bitmap. Muting is indicated. Here, if a bit corresponding to the first repetition 1620-1 of the 2-bit option 2 bitmap indicates muting, the corresponding DL PRS resource 1620-1 is muted. In addition, if a bit corresponding to the second iteration 1620-2 of the DL PRS resource in the 2-bit option 2 bitmap indicates muting, the corresponding DL PRS resource 1620-2 is muted. Option 2 bitmap may be applied when option 1 bitmap indicates not to be muted.

On the other hand, if the bit corresponding to the first repetition 1620-1 of the DL PRS resource among the option 2 bitmaps indicates that the bit is not muted, N DLs in the first repetition 1620-1 of the DL PRS resource If a bit of the option 3 bitmap corresponding to the PRS symbol indicates muting, the corresponding DL PRS is muted.

That is, for A bits corresponding to N DL PRS symbols in the first iteration 1620-1 of the DL PRS resource, if the bit value is 0 (or 1), the corresponding DL PRS is muted, and vice versa If the value is 1 (or 0), the corresponding DL PRS is not muted.

For example, if N=2 and A=6 and the bit value of the option 3 bitmap is 100010, the DL PRS at the ½th symbol and the 9/10th symbol out of a total of 2*6=12 symbols are muting If not, the DL PRS in the remaining symbols becomes muting.

As another example, if N=4 and A=3 and the bit value of the option 3 bitmap is 010, the DL PRS in the 5/6/7/8 symbols out of a total of 4*3=12 symbols is muting If not, the DL PRS in the remaining symbols is muting.

This is also applied to the other DL PRS resources 1620-2, 1620-3, 1620-4, 1620-5, 1620-6, 1620-7, and 1620-8 shown in FIG. 16, respectively. However, FIG. 16 is only one example, and is not limited thereto.

In this case, in application of the option 3 bitmap, the option 1 bitmap and/or the option 2 bitmap may or may not exist. If both the option 1 bitmap and the option 2 bitmap exist, the option 3 bitmap may be applied when the option 1 bitmap and the option 2 bitmap indicate not to be muted. If the option 1 bitmap does not exist, the reporting operation may be performed in the same case as the case in which the option 1 bitmap indicates not to be muted. Similarly, if the option 2 bitmap does not exist, the reporting operation may be performed in the same case as the case in which the option 2 bitmap indicates not to be muted.

FIG. 17 to FIG. 18 are diagrams more specifically illustrating an option 3 bitmap applicable to the present disclosure.

Referring to FIG. 17, when the comb size is 2 (Comb-2) within a slot, each bit of the option 3 bitmap may correspond to 2 symbols. Referring to (a) of FIG. 17, a case in which four DL PRS symbols are allocated as DL-PRS in one slot as one single PRS repetition may be considered. In this case, since 1 bit corresponds to 2 DL PRS symbol units, in the case of 4 symbols, the option 3 bitmap may be 2 bits.

Referring to (b) of FIG. 17, a case in which six DL PRS symbols are allocated as DL-PRS in one slot as one single PRS repetition may be considered. In this case, since 1 bit corresponds to 2 symbol units, in the case of 6 symbols, the option 3 bitmap may be 3 bits.

Referring to (c) of FIG. 17, it may be considered that 12 DL PRS symbols are allocated as DL-PRS in one slot as one PRS repetition. In this case, since 1 bit corresponds to 2 symbol units, in the case of 12 symbols, the option 3 bitmap may be 6 bits.

Referring to (a) of FIG. 18, when the comb size in a slot is 4 (Comb 4), each bit of the option 3 bitmap may correspond to 4 DL PRS symbols. For example, a case in which 12 DL PRS symbols are allocated as DL-PRS in one slot as one PRS repetition (single PRS repetition) may be considered. In this case, since 1 bit corresponds to 4 DL PRS symbol units, in the case of 12 symbols, the option 3 bitmap may be 3 bits.

Referring to (b) of FIG. 18, when the comb size within a slot is 6 (Comb 6), each bit of the option 3 bitmap may correspond to 6 DL PRS symbols. For example, a case in which 12 DL PRS symbols are allocated as DL-PRS in one slot as one PRS repetition (single PRS repetition) may be considered. In this case, since 1 bit corresponds to 6 DL PRS symbols, in the case of 12 symbols, the option 3 bitmap may be 2 bits.

The option 3 bitmap may indicate muting for DL PRS in units of symbols corresponding to units of comb size. Here, when muting is instructed to the terminal based on the option 1 bitmap, all DL PRSs of the corresponding occasion may be muted. On the other hand, in the case of the option 2 bitmap, all DL PRSs of corresponding repetitions for which muting is instructed through the option 2 bitmap among occasions in which muting is not instructed to the UE based on the option 1 bitmap may be muted. That is, only DL PRS resources indicated that neither the option 1 bitmap nor the option 2 bitmap are muted among the DL PRSs can be used, as described above.

In addition, in the case of the option 3 bitmap, the option 3 bitmap is generated in units of N symbols within repetitions in which muting is not instructed through the option 2 bitmap among occasions in which muting is not instructed to the terminal based on the option 1 bitmap. Through this, the DL PRS for which muting is instructed may be muted. That is, only DL PRS resources indicated as non-muted by option 1 bitmap, option 2 bitmap, and option 3 bitmap among DL PRSs may be used.

Therefore, in a new communication system, muting for DL PRS can be instructed flexibly, and through this, overhead can be reduced to satisfy requirements considering positioning.

Next, a case in which positioning is performed based on uplink will be described. Hereinafter, for ease of explanation, positioning is referred to as “UL SRS for positioning”, but this is only one name and is not limited to the above-mentioned name. In addition, it can be applied by being changed to a different name to a newly proposed communication system, and can also be applied in a form changed according to a new communication system. In addition, positioning based on uplink disclosed in the present invention may be performed through an SRS for positioning. The SRS for positioning is referred to as “SRS for positioning”, but is not limited to the above-mentioned name.

For example, an SRS for a positioning operation may be generated in the NR system. Here, the number of SRS symbols may be 1, 2 or 4 for SRS for MIMO (Multi Input Multi Output). In this case, since more SRSs may be required in the case of SRSs for positioning, 1, 2, 4, 8 or 12 SRS symbols may be used. In addition, the position of the SRS symbol may be used up to the Nth symbol (N=0, 1 . . . 13) from the end of the slot. That is, the SRS symbol may be allocated based on the end of the slot. Also, as an example, the number of SRS combs may be 2, 4, or 8, which will be described later. Also, as an example, an offset may be applied in SRS mapping, and may be shown in Table 9 below.

TABLE 9

| | k_{offset}⁰, . . . , k_{offset}^{NsymbSRS-1} | | | | |
|---|---|---|---|---|---|
| K_{TC} | N_{symb}^{SRS} = 1 | N_{symb}^{SRS} = 2 | N_{symb}^{SRS} = 4 | N_{symb}^{SRS} = 8 | N_{symb}^{SRS} = 12 |
| 2 | 0 | 0, 1 | 0, 1, 0, 1 | — | — |
| 4 | — | 0, 2 | 0, 2, 1, 3 | 0, 2, 1, 3, 0, 2, 1, 3 | 0, 2, 1, 3, 0, 2, 1, 3, 0, 2, 1, 3 |
| 8 | — | — | 0, 4, 2, 6 | 0, 4, 2, 6, 1, 5, 3, 7 | 0, 4, 2, 6, 1, 5, 3, 7, 0, 4, 2, 6 |

The sequence of SRS may be a sequence based on Zadoff-chu. For example, the SRS sequence may be generated based on Equation 4 below. In this case, n may be a subcarrier index and l′ may be a symbol. At this time, 0≤n≤M_{sc,b}^{SRS}−1, and l′∈{0,1, . . . , N_{symb}^{SRS}−1}. pi may be an antenna port. For example, since the SRS for positioning uses only one antenna port, the pi value may be 1. α_i may be a Cyclic Shift (CS) value, α_i may be equal to Equations 5 and 6 below, and an SRS sequence may be generated based thereon. At this time, it may be N_{SRS}^{cs}∈{0, 1, . . . , n_{SRS}^{cs,max}−1} in Equation 6. Here, the SRS sequence may maintain orthogonality by shifting the phase based on Equations 5 and 6 below.

$${r}^{( {p}_{i} )} ( n , {l}^{′} ) = {r}_{u , v}^{( {α}_{i} , δ )} ( n ) , \qquad [ Equation 4 ]$$

$${α}_{i} = 2 π \frac{{n}_{SRS}^{cs , i}}{{n}_{SRS}^{cs , ma x}} \qquad [ Equation 5 ]$$

$${n}_{SRS}^{cs , i} = ( {n}_{SRS}^{cs} + \frac{{n}_{SRS}^{cs , ma x} ( {p}_{i} - 1000 )}{{N}_{ap}^{SRS}} ) mod {n}_{SRS}^{cs , ma x} \qquad [ Equation 6 ]$$

According to the present invention, the number of SRS combs can be variously set to 2, 4 or 8. For example, in accordance with the LTE system, the number of combs is 4, and based on this, 12 CSs can be used. The number of combs according to the present invention can be set by applying different numbers depending on the applied system.

Considering the SRS for positioning in the new communication system according to the present invention, when the comb size is 2, the maximum number of CSs may be 8. Also, when the comb size is 4, the maximum number of CSs may be 12. Also, since the SRS can be used for positioning, a comb size of 8 can also be considered.

For example, SRS for positioning can support only one antenna port. SRS for positioning does not support frequency hopping, and 4 PRB to 272 PRB may be supported for frequency axis allocation in units of 4 PRB. In addition, in the case of SRS for positioning, aperiodic may be supported in the same way as aperiodic SRS. Information on the antenna port, frequency hopping, frequency allocation, and period may be indicated through higher-level signaling.

In the case of SRS for positioning, requirements must be satisfied in consideration of IIOT scenarios or use cases, and for this purpose, a method of increasing orthogonality or reducing overhead may be required.

To this end, the number of SRS symbols for positioning may be 1, 2, 4, 8 or 12. Also, the comb size for positioning may be 2, 4 or 8. Here, the SRS may be a Zadoff Chu sequence based on a phase shift. In this case, CS may be a value for phase shift, and orthogonality may be maintained for each value phase shifted based on the CS value. In this regard, Table 10 below shows the number of orthogonal resources within one slot. Here, the number of orthogonal resources can be expressed as the product of the comb size and the maximum number of CSs. Specifically, when the comb size is 2, since the maximum number of CSs is 8, the number of orthogonal resources may be 16. Also, when the comb size is 4, since the maximum number of CSs is 12, the number of orthogonal resources may be 48. In addition, in the case of a comb size of 8, since the maximum number of CSs is 6, the number of orthogonal resources may be 48, as shown in Table 10 below.

Also, Table 11 shows the number of orthogonal resources considering a delay spread environment. In this case, the number of orthogonal resources may be the product of a staggered pattern considering delay spread and the maximum number of CSs. For example, considering the delay spread environment, if the comb size is 2, orthogonality can be maintained when two SRS symbols exist.

On the other hand, when there is only one SRS symbol, since orthogonality is not maintained by delay spreading, patterns maintaining orthogonality may be reduced by half. A staggered pattern considering such a delay spread may be 1 when the comb size is 2 and the SRS symbol is 1. On the other hand, a staggered pattern considering delay spread may be 2 when the comb size is 2 and the number of SRS symbols is 2 or more. A staggered pattern considering delay spread in the same way can be 2 when the comb size is 4 and the SRS symbol is 2. On the other hand, a staggered pattern considering delay spread may be 4 when the comb size is 4 and the number of SRS symbols is 4 or more. The staggered pattern considering the delay spread may be 4 when the comb size is 8 and the SRS symbol is 4. On the other hand, a staggered pattern considering delay spread may be 8 when the comb size is 8 and the number of SRS symbols is 8 or more. Based on the above, when the number of SRS symbols is small in a delay spread environment, the number of orthogonal resources in Table 11 can be reduced compared to Table 10.

TABLE 10

| | | Number of SRS symbols | | | | |
|---|---|---|---|---|---|---|
| | | 1 | 2 | 4 | 8 | 12 |
| Comb | 2 | 16 | 16 | 16 | N/A | N/A |
| Size | 4 | N/A | 48 | 48 | 48 | 48 |
| | 8 | N/A | N/A | 48 | 48 | 48 |

TABLE 11

| | | Number of SRS symbols | | | | |
|---|---|---|---|---|---|---|
| | | 1 | 2 | 4 | 8 | 12 |
| Comb | 2 | 8 | 16 | 16 | N/A | N/A |
| Size | 4 | N/A | 24 | 48 | 48 | 48 |
| | 8 | N/A | N/A | 24 | 48 | 48 |

In addition, considering a use case of a new communication system (e.g., NR) or an IIoT scenario, an environment of high cell density and small cell size may be considered. In this case, many orthogonal resources may be required to avoid collision between cells. For example, in the case of an IIOT scenario, positioning using one symbol may be performed, and when Table 11 is applied, a problem of reducing orthogonal resources may occur. In other words, there is a need to consider an environment where the cell size is small and delay spread exists with respect to the requirements for positioning. That is, a design may be required to satisfy the requirements for low delay in an environment where the cell size is small and delay spread exists. At this time, a method of increasing the maximum number of CSs may be considered to maintain orthogonality. The number of orthogonal resources may be the product of the maximum number of CSs and a pattern considering delay spread. Therefore, increasing the maximum number of CSs can increase the number of orthogonal resources. However, as an example, since the SRS symbol is a Zadoff Chu sequence and the CS may be a value for phase shift, when the number of CSs increases, the phase value corresponding to each sequence may decrease. Here, when the phase value corresponding to each sequence is small, the effect may be large when a phase delay occurs. That is, orthogonality may not be maintained due to the phase delay. Thus, a method of determining the maximum number of CSs may be needed.

For example, the maximum number of CSs can be determined as shown in Table 12 below. When the comb size is 2, the maximum number of existing CSs may be 8. Here, the maximum number of CSs can be determined as {8, 12, 24, 48} or {8, 12, 24, 48, 96}. Also, when the comb size is 4, the maximum number of CSs is 12, or may be determined as {12, 24} or {12, 24, 48}. In addition, when the comb size is 8, the maximum number of CSs is 6. Considering this, the maximum number of CSs can be determined as {6, 12, 24} or {6, 12, 24}.

TABLE 12

Comb size = 2
Maximum number of CS: 8
Method: {8, 12, 24, 48} or {8, 12, 24, 48, 96}
Comb size = 4
Maximum number of CS: 12
Method: {12, 24} or {12, 24, 48}
Comb size = 8
Maximum number of CS: 6
Method: {6, 12} or {6, 12, 24}

Here, even when the maximum number of CSs is determined as shown in Table 12 below, if the number of available subcarriers (ie, the number of frequency domain REs) within the allocated PRB (Physical Resource Block) is not divided by the maximum number of CSs, the actual Orthogonality may not be guaranteed. As a method for solving this problem, for example, when resources are allocated in units of 4 PRB (=48RE) and the comb size is 2, the number of frequency axis REs per pattern may be 24. In this case, when the comb size is 2 and the maximum number of CSs is 8, since 24 is a multiple of 8, orthogonality can be maintained. On the other hand, when the maximum number of CSs is 16 or 48, orthogonality may not be maintained because it is not a multiple of 24.

More specifically, Table 13 below shows cases where orthogonality is maintained and cases where it is not. In this case, when the comb size is 2 and the maximum number of CSs is 48 or 96, orthogonality may not be maintained because 24 REs are allocated per pattern for one 4 PRB unit. In addition, in the case of a comb size of 4, since 12 REs (48 RE/4) are allocated per pattern for 4 PRB units, orthogonality can be maintained if the maximum number of CSs is 12. On the other hand, when the maximum number of CSs is 24 or 48, orthogonality may not be maintained. In addition, in the case of a comb size of 8, since 6 REs (48 RE/8) are allocated per pattern for 4 PRB units, orthogonality can be maintained if the maximum number of CSs is 6. On the other hand, when the maximum number of CSs is 12 or 24, orthogonality may not be maintained.

TABLE 13
Comb size = 2
Max. # of CS values: 8, required number of REs must be a multiple of 8, satisfied with
allocation of 4 PRB (total 24 REs) units
Max. # of CS values: 12, the required number of REs must be a multiple of 12, satisfied
with the allocation of 4 PRB (total 24 REs) units
Max. # of CS values: 24, the required number of REs must be a multiple of 24, satisfied
with the allocation of 4 PRB (total 24 REs) units
Max. # of CS values: 48, the required number of REs must be a multiple of 48, not satisfied
with the allocation of 4 PRB (total 24 REs) units. Requires allocation of at least 8 PRB (total
of 48 REs) units
Max. # of CS values: 96, the required number of REs must be a multiple of 96, not satisfied
with the allocation of 4PRB (total 24 REs) units. Requires allocation of at least 16 PRB (total
of 96 REs) units
Comb size = 4
Max. # of CS values: 12, the required number of REs must be a multiple of 12, satisfied
with the allocation of 4 PRB (total 12 REs) units
Max. # of CS values: 24, the required number of REs must be a multiple of 24, not satisfied
with the allocation of 4 PRB (total 12 REs) units. Requires allocation of at least 8 PRB (total
of 24 REs) units
Max. # of CS values: 48, the required number of REs must be a multiple of 48, not satisfied
with the allocation of 4 PRB (total 12 REs) units. Requires allocation of at least 16 PRB
(total of 48 REs) units
Comb size = 8
Max. # of CS values: 6, the required number of REs must be a multiple of 6, satisfies the
allocation of 4 PRB (a total of 6 REs) units
Max. # of CS values: 12, the required number of REs must be a multiple of 12, not satisfied
with the allocation of 4 PRB (a total of 6 REs) units. Requires allocation of at least 8 PRB
(total of 12 REs) units
Max. # of CS values: 24, the required number of REs must be a multiple of 24, not satisfied
with the allocation of 4 PRB (total 6 REs) units. Requires allocation of at least 16 PRB (total
of 24 REs) units

As described, there is a need to consider the number of PRBs in determining the maximum number of CSs for orthogonality. For example, the maximum number of CSs may be determined in consideration of the number of allocated PRBs and the comb size. That is, the maximum number of CSs may have different values depending on the number of allocated PRBs and the comb size. At this time, referring to Table 14, the UE can check the number of allocated PRBs and the comb size through higher-level signaling. In this case, as the maximum number of CSs, one of the maximum number of CSs having different ranges may be selected based on the signaled number of assigned PRBs and comb size information. That is, the terminal may check the signaled number of assigned PRBs and comb size information through signaling, and select a specific value for the maximum CS number from a corresponding maximum CS number candidate group. Here, as an example, a specific maximum CS number value selected from the maximum CS number candidate group may also be indicated through upper stage signaling, but is not limited thereto.

Specifically, in Table 14, mSRS,b may be the number of PRBs. In this case, mSRS,b case #1 may be a case of 4 PRB units. That is, (mSRS,b)mod 4=0, (mSRS,b)mod 8≠0, and (mSRS,b)mod 16≠0. Here, mod means modular operation. In this case, when the comb size is 2, the maximum number of CSs may be 8, 12 or 24. Here, the terminal may be instructed to specify the maximum number of CSs among 8, 12, or 24 through higher-level signaling. In addition, when the comb size is 4, the maximum number of CSs is 12, and the terminal can select 12 as the maximum number of CSs. In addition, when the comb size is 8, the maximum number of CSs is 6, and the terminal can select 6 as the maximum number of CSs.

In addition, mSRS,b case #2 may be a case of 8 PRB units. That is, (mSRS,b)mod 8=0 and (mSRS,b)mod 16≠0. In this case, when the comb size is 2, the maximum number of CSs may be 8, 12, 24, or 48. Here, the terminal may be instructed to specify the maximum number of CSs among 8, 12, 24, or 48 through higher-level signaling. Also, when the comb size is 4, the maximum number of CSs may be 12 or 24. Here, the terminal may be instructed to specify the maximum number of CSs of 12 or 24 through higher-level signaling. Also, when the comb size is 8, the maximum number of CSs may be 6 or 12. Here, the terminal may be instructed to specify the maximum number of CSs among 6 and 12 through higher-level signaling.

In addition, mSRS,b case #3 may be a case of 16 PRB units. That is, (mSRS,b)mod 16=0. In this case, when the comb size is 2, the maximum number of CSs may be 8, 12, 24, 48 or 96. Here, the UE may be instructed to specify the maximum number of CSs among 8, 12, 24, 48, or 96 through higher-level signaling. Also, when the comb size is 4, the maximum number of CSs may be 12, 24 or 48. Here, the UE may be instructed to specify the maximum number of CSs among 12, 24, or 48 through higher-level signaling. Also, when the comb size is 8, the maximum number of CSs may be 6, 12 or 24. Here, the UE may be instructed to specify the maximum number of CSs among 6, 12, or 24 through higher-level signaling.

That is, the UE may select the maximum number of CSs based on information on the number of PRBs and the comb size.

TABLE 14

| | Comb size = 2 | Comb size = 4 | Comb size = 8 |
|---|---|---|---|
| M_{SRS,b} case#1 | {8, 12, 24} | 12 | 6 |
| M_{SRS,b} case#2 | {8, 12, 24, 48} | {12, 24} | {6,12} |
| M_{SRS,b} case#3 | {8, 12, 24, 48, 96} | {12, 24, 48} | {6, 12, 24} |

As another example, the terminal may select a specific maximum number of CSs from among maximum number of CSs having different ranges based on the comb size allocated through upper signaling. Here, the higher-level signaling may be RRC (Radio Resource Control) signaling. At this time, the UE may receive an indication of a specific maximum number of CSs selected from among maximum number of CSs having different ranges through higher level signaling. Here, as an example, the maximum number of CSs having different ranges may be shown in Table 15 below. That is, the UE may not receive signaling of information on the number of PRBs, and thus signaling overhead may be reduced. Here, the number of PRBs may be reflected in advance.

TABLE 15

| Comb size = 2 | Comb size = 4 | Comb size = 8 |
|---|---|---|
| {8, 12, 24, 48, 96} | {12, 24, 48} | {6, 12, 24} |

Specifically, the SRS for positioning may be defined based on one antenna port. In this case, as an example, since it is defined based on one antenna port, Equation 5 for the above-described CS value may be the same as Equation 7 below. Here, it can be In addition, as described above, Equation 7 may be changed to Equation 8 to reflect the number of PRBs in advance.

$${α}_{i} = 2 π \frac{{n}_{SRS}^{cs}}{{n}_{SRS}^{cs , max}} \qquad [ Equation 7 ]$$

$${α}_{i} = 2 π \frac{A \cdot {n}_{SRS}^{cs}}{{n}_{SRS}^{cs , max}} \qquad [ Equation 8 ]$$

In Equation 8, the value A may be determined based on at least one of the maximum allocated PRB number (m_{SRS,b}), the value for the maximum CS number (n^{CS,max}_{SRS}), and the comb size (K_{TC}). That is, the CS value may be derived differently depending on the A value.

For example, in the case of Equation 9, A=1. If the product of the comb size and the maximum number of CSs is less than 48, A=1 may be obtained. That is, if resources can be allocated in units of 4 PRBs (48 REs) based on the comb size and the maximum number of CSs, Equation 9 below can be satisfied, and the number of CSs can be determined based on this.

$${K}_{TC} \cdot {{n}^{CS , max}}_{SRS} \leq 48 \qquad [ Equation 9 ]$$

On the other hand, a case where the product of the comb size and the maximum number of CSs satisfies Equation 10 may be considered. At this time, if (m_{SRS,b})mod 8=0 in consideration of the number of PRBs, A=1 may be. On the other hand, if (m_{SRS,b})mod 8≠0, A may be 2. Here, if A is 2, the possible CS number value (aᵢ) becomes small, and a value maintaining orthogonality can be derived.

In Equation 10 below, in the case of 8 PRB units, A may be 1, and based on this, the number of CSs is determined. In the case of 4 PRB units, A may be 2 and the number of CSs may be small.

$${K}_{TC} \cdot {{n}^{CS , max}}_{SRS} = 96 \qquad [ Equation 10 ]$$

In addition, a case where the product of the comb size and the maximum number of CSs satisfies Equation 11 may be considered. At this time, if (m_{SRS,b})mod 16=0 in consideration of the number of PRBs, A may be 1. On the other hand, if (m_{SRS,b})mod 16≠0 and (m_{SRS,b})mod 8=0, A may be 2. On the other hand, if (m_{SRS,b})mod 16≠0 and (m_{SRS,b})mod 8≠0, A may be 4. That is, in the case of 16 PRB units in Equation 11 below, A is 1, and the number of CSs may be determined based on this.

On the other hand, in the case of 8 PRB units, A is 2 and the CS number value can be reduced by half, and in the case of 4 PRB units, A is 4 and the CS number value can be reduced to ¼.

$${K}_{TC} \cdot {{n}^{CS , max}}_{SRS} = 192 \qquad [ Equation 11 ]$$

Here, when K_{TC}·n^{CS,max}_{SRS}≤48, when the comb size is 2, the maximum number of CSs (n^{CS,max}_{SRS}) may be 8, 12, or 24. Also, when the comb size is 4, the maximum number of CSs (n^{CS,max}_{SRS}) may be 12. Also, when the comb size is 8, the maximum number of CSs (n^{CS,max}_{SRS}) may be 6. In addition, when K_{TC}·n^{CS,max}_{SRS}=96, when the comb size is 2, the maximum number of CSs (n^{CS,max}_{SRS}) may be 48. Also, when the comb size is 4, the maximum number of CSs (n^{CS,max}_{SRS}) may be 24. Also, when the comb size is 8, the maximum number of CSs (n^{CS,max}_{SRS}) may be 12.

As described above, when the number of PRBs (m_{SRS,b}) is a multiple of 8 (ie, in units of 8 PRBs), A may be 1 so that all CS values (n_{SRS}^{cs}∈{0, 1, . . . , n_{SRS}^{cs,max}−1}) can be applied. On the other hand, if it is not a multiple of 8, A may be 2 so that only ½ of n_{SRS}^{cs}∈{0, 1, . . . n_{SRS}^{CS,max}−1} can be applied. At this time, n^{CS}_{SRS} and n^{CS}_{SRS}+n^{CS,max}_{SRS}/2 may be applied as substantially the same value. In this case, orthogonality may be maintained by applying a phase of CS in units of 4 PRBs one turn.

In addition, when K_{TC}·n^{CS,max}_{SRS}=192, when the comb size is 2, the maximum number of CSs (n^{CS,max}_{SRS}) may be 96. Also, when the comb size is 4, the maximum number of CSs (n^{CS,max}_{SRS}) may be 48. Also, when the comb size is 8, the maximum number of CSs (n^{CS,max}_{SRS}) may be 24.

As described above, when the number of PRBs (m_{SRS,b}) is a multiple of 16 (ie, in units of 16 PRBs), A may be 1 so that all CS values (n_{SRS}^{cs}∈{0, 1, . . . , n_{SRS}^{cs,max}−1}) can be applied. On the other hand, if it is not a multiple of 16 and is a multiple of 8 (ie, 8 PRB units), A may be 2 so that only ½ of n_{SRS}^{cs}∈{0, 1, . . . , n_{SRS}^{cs,max}−1} can be applied. At this time, n^{CS}_{SRS} and n^{CS}_{SRS}+n^{CS,max}_{SRS}/2 may be applied as substantially the same value. Therefore, orthogonality can be maintained by applying the phase of the CS once in units of 8 PRB.

On the other hand, when it is neither a multiple of 16 nor a multiple of 8 (ie, in the case of a 4 PRB unit), A may be 4 so that only ¼ of n_{SRS}^{cs}∈{0, 1, . . . , n_{SRS}^{cs,max}−1} can be applied. In this case, n^{CS}_{SRS} and n^{CS}_{SRS}+n^{CS,max}_{SRS}/4, n^{CS}_{SRS}+n^{CS,max}_{SRS}/2, and n^{CS}_{SRS}+3n^{CS,max}_{SRS}/4 may be substantially the same value. Therefore, orthogonality can be maintained by applying the CS phase one turn in units of 4 PRBs.

As an example, Table 16 below may be an example of 4 PRB allocation. Here, r_{u,v}^{(α,δ)}(n)=e^{jαn}r̅_{u,v}(n), 0≤n<M_{ZC}, may correspond to αn (CS value*subcarrier index), and n^{CS}_{SRS} may be 1.

TABLE 16

| Subcarrier | n^{CS,max}_{SRS} = 24, | n^{CS,max}_{SRS} = 48, | n^{CS,max}_{SRS} = 96, |
|---|---|---|---|
| index(K_{TC} = 2) | A = 1 | A = 2 | A = 4 |
| 46 | 23/24 | 46/48 | 92/96 |
| 44 | 22/24 | 44/48 | 88/96 |
| 42 | 21/24 | 42/48 | 84/96 |
| 40 | 20/24 | 40/48 | 80/96 |
| 38 | 19/24 | 38/48 | 76/96 |
| 36 | 18/24 | 36/48 | 72/96 |
| 34 | 17/24 | 34/48 | 68/96 |
| 32 | 16/24 | 32/48 | 64/96 |
| 30 | 15/24 | 30/48 | 60/96 |
| 28 | 14/24 | 28/48 | 56/96 |
| 26 | 13/24 | 26/48 | 52/96 |
| 24 | 12/24 | 24/48 | 48/96 |
| 22 | 11/24 | 22/48 | 44/96 |
| 20 | 10/24 | 20/48 | 40/96 |
| 18 | 9/24 | 18/48 | 36/96 |
| 16 | 8/24 | 16/48 | 32/96 |
| 14 | 7/24 | 14/48 | 28/96 |
| 12 | 6/24 | 12/48 | 24/96 |
| 10 | 5/24 | 10/48 | 20/96 |
| 8 | 4/24 | 8/48 | 16/96 |
| 6 | 3/24 | 6/48 | 12/96 |
| 4 | 2/24 | 4/48 | 8/96 |
| 2 | 1/24 | 2/48 | 4/96 |
| 0 | 0 | 0 | 0 |

As another example, Equation 8 described above may be changed to Equation 12 below.

$${α}_{i} = 2 π \frac{A \cdot {n}_{SRS}^{cs} + B}{{n}_{SRS}^{cs , max}} \qquad [ Equation 12 ]$$

Here, the value A may be determined based on at least one of the maximum number of allocated PRBs (m_{SRS,b}), the value for the maximum number of CSs (n^{CS,max}_{SRS}), and the comb size (K_{TC}). That is, the CS value may be derived differently according to the A value, which may be the same as Equations 9 to 11 and Table 16 described above. If A is 1, all n_{SRS}^{cs}∈{0, 1, . . . , n_{SRS}^{cs,max}−1} are applicable. On the other hand, if A is 2, only ½ of them can be applied. In addition, when A is 4, only ¼ of them can be applied.

At this time, for example, when only ½ is applied when A=2 and only ¼ is applied when A=4, there is a need to improve performance for positioning, and the B value can be used. However, it can be applied to the case of transmitting the SRS for positioning in a plurality of symbols.

Specifically, when A is 1, B may be 0, which may be the same as before. On the other hand, when A is 2, B may be set to 0 in the SRS transmission symbol for the first positioning. On the other hand, B may be set to 1 in SRS transmission for the second positioning. In addition, the SRS transmission symbol for the third positioning is the same as the SRS transmission symbol for the first positioning, and the SRS transmission symbol for the fourth positioning is the same as the SRS transmission symbol for the second positioning, and may be repeated in subsequent symbols.

In addition, when A is 4, B may be set to 0 in the SRS transmission symbol for the first positioning. On the other hand, B may be set to 2 in SRS transmission for the second positioning. In addition, B may be set to 1 in SRS transmission for the third positioning. In addition, B may be set to 3 in SRS transmission for the fourth positioning. In addition, the SRS transmission symbol for the fifth positioning is the same as the SRS transmission symbol for the first positioning, the SRS transmission symbol for the sixth positioning is the same as the SRS transmission symbol for the second positioning, and the SRS transmission symbol for the seventh positioning The transmission symbol is the same as the SRS transmission symbol for the third positioning, the SRS transmission symbol for the eighth positioning is the same as the SRS transmission symbol for the fourth positioning, and may be repeated in subsequent symbols.

Therefore, even when A is 2, considering two symbols, all of n_{SRS}^{cs}∈{0, 1, . . . , n_{SRS}^{cs,max}−1} can be used. In addition, even when A is 4, all of n_{SRS}^{cs}∈{0, 1, . . . , n_{SRS}^{cs,max}−1} may be used for 4 symbols.

In this case, as an example, Table 17 below may be an example of 4 PRB allocation when A is 2 based on Equation 12 described above. Here, r_{u,v}^{(α,δ)}(n)=e^{jαn}r̅_{u,v}(n), 0≤n<M_{ZC}, may correspond to αn (CS value*subcarrier index), and n^{CS}_{SRS} may be 1. Also, n^{CS,max}_{SRS} may be 48 and K_{TC} may be 2.

TABLE 17

| Subcarrier | | |
|---|---|---|
| index | A = 2, B = 0 | A = 2, B = 1 |
| 46 | 46/48 | 47/48 |
| 44 | 44/48 | 45/48 |
| 42 | 42/48 | 43/48 |
| 40 | 40/48 | 41/48 |
| 38 | 38/48 | 39/48 |
| 36 | 36/48 | 37/48 |
| 34 | 34/48 | 35/48 |
| 32 | 32/48 | 33/48 |
| 30 | 30/48 | 31/48 |
| 28 | 28/48 | 29/48 |
| 26 | 26/48 | 27/48 |
| 24 | 24/48 | 25/48 |
| 22 | 22/48 | 23/48 |
| 20 | 20/48 | 21/48 |
| 18 | 18/48 | 19/48 |
| 16 | 16/48 | 17/48 |
| 14 | 14/48 | 15/48 |
| 12 | 12/48 | 13/48 |
| 10 | 10/48 | 11/48 |
| 8 | 8/48 | 9/48 |
| 6 | 6/48 | 7/48 |
| 4 | 4/48 | 5/48 |
| 2 | 2/48 | 3/48 |
| 0 | 0 | 1/48 |

In addition, Table 18 below may be an example of 4 PRB allocation when A is 4 based on Equation 12 described above. Here, r_{u,v}^{(α,δ)}(n)=e^{jαn}r̅_{u,v}(n), 0≤n<M_{ZC}, may correspond to αn (CS value*subcarrier index), and n^{CS}_{SRS} may be 1. Also, n^{CS,max}_{SRS} may be 48 and K_{TC} may be 2.

TABLE 18

| Subcarrier | | | | |
|---|---|---|---|---|
| index | A = 4, B = 0 | A = 4, B = 2 | A = 4, B = 1 | A = 4, B = 3 |
| 46 | 92/96 | 94/96 | 93/96 | 95/96 |
| 44 | 88/96 | 90/96 | 89/96 | 91/96 |
| 42 | 84/96 | 86/96 | 85/96 | 87/96 |
| 40 | 80/96 | 82/96 | 81/96 | 83/96 |
| 38 | 76/96 | 78/96 | 77/96 | 79/96 |
| 36 | 72/96 | 74/96 | 73/96 | 75/96 |
| 34 | 68/96 | 70/96 | 69/96 | 71/96 |
| 32 | 64/96 | 66/96 | 65/96 | 67/96 |
| 30 | 60/96 | 62/96 | 61/96 | 63/96 |
| 28 | 56/96 | 58/96 | 57/96 | 59/96 |
| 26 | 52/96 | 54/96 | 53/96 | 55/96 |
| 24 | 48/96 | 50/96 | 49/96 | 51/96 |
| 22 | 44/96 | 46/96 | 45/96 | 47/96 |
| 20 | 40/96 | 42/96 | 41/96 | 43/96 |
| 18 | 36/96 | 38/96 | 37/96 | 39/96 |
| 16 | 32/96 | 34/96 | 33/96 | 35/96 |
| 14 | 28/96 | 30/96 | 29/96 | 31/96 |
| 12 | 24/96 | 26/96 | 25/96 | 27/96 |
| 10 | 20/96 | 22/96 | 21/96 | 23/96 |
| 8 | 16/96 | 18/96 | 17/96 | 19/96 |
| 6 | 12/96 | 14/96 | 13/96 | 15/96 |
| 4 | 8/96 | 10/96 | 9/96 | 11/96 |
| 2 | 4/96 | 6/96 | 5/96 | 7/96 |
| 0 | 0 | 2/96 | 1/96 | 3/96 |

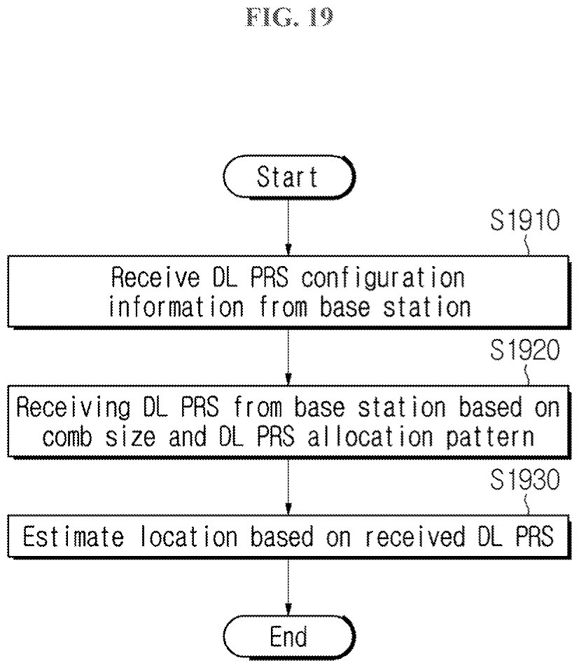

FIG. 19 is a flowchart for explaining an example of a method of generating a PRS applicable to the present disclosure.

For example, the terminal may receive DL PRS configuration information from the base station (S1910). At this time, as described above with reference to FIGS. 5 to 14, the DL PRS configuration information may include DL PRS reception-related information. Here, the DL PRS configuration information may include comb size and DL PRS allocation pattern information. For example, the comb size may be 2, 4, 6 or 12, as described above. Also, as an example, the DL PRS allocation pattern may be derived based on Equation 3 so that orthogonality can be maintained even when frequency axis transposition and time axis transposition are performed as described above. For example, when the comb size is 6, the DL PRS allocation pattern may be {0,2, 1,4,5,3}. Also, as an example, when the comb size is 12, the DL PRS allocation pattern may be {0,1,4,2,9,5,11,3,8,10,7,6}.

The UE may receive a DL PRS based on the comb size and the DL PRS allocation pattern (S1910), and perform location estimation based on the received DL PRS (S1920). This is as described above with reference to FIGS. 5 to 16. In addition, the DL PRS resource related ID may be distinguished based on a time axis shift value and a frequency axis shift value based on the DL PRS allocation pattern. At this time, the terminal may receive the DL PRS based on the DL PRS resource related ID. For example, a PRS resource ID may correspond to each DL PRS resource. In this case, the PRS resource ID may have different frequency axis shift values and time axis shift values based on the above-described DL PRS pattern. As another example, the frequency axis shift value and the time axis shift value may be different according to the PRS sequence ID, and through this, the DL PRS can be distinguished. As another example, the frequency axis shift value may be set differently according to the PRS resource ID. Additionally, a time axis shift value may be set differently according to the PRS resource set ID. As another example, the frequency axis shift value may be set differently according to the PRS resource ID. Additionally, a time axis shift value may be set differently according to the PRS sequence ID, as described above.

Also, as an example, the terminal may receive bitmap information indicating the DL PRS muting from the base station. At this time, the UE may perform DL PRS muting based on the received bitmap information. In this case, the bitmap information may include at least one of first bitmap information, second bitmap information, and third bitmap information. In this case, the first bitmap information may indicate muting for the DL PRS in units of occasions. In addition, the second bitmap information may indicate muting for DL PRS in repetition units within an occasion. Here, the repetition unit may be one slot. Also, as an example, the third bitmap information may indicate muting for DL PRS in units of a plurality of symbols in repetition.

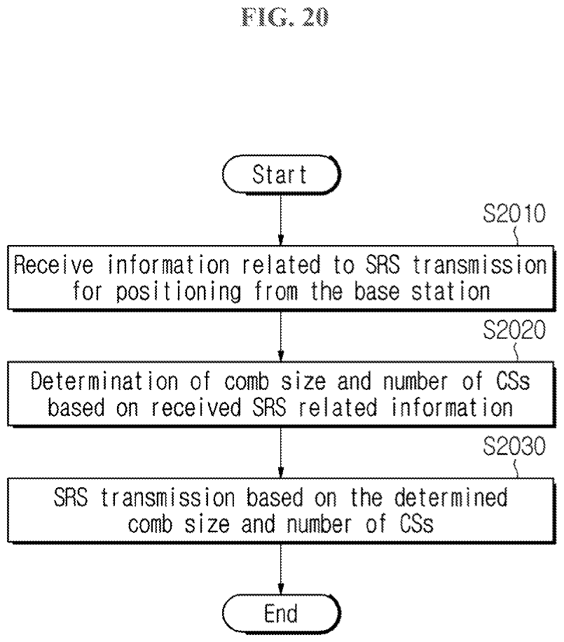

FIG. 20 is a flowchart for explaining an example of a method of generating a PRS applicable to the present disclosure.

Referring to FIG. 20, a UE may receive SRS transmission-related information for positioning from a base station. (S2010) At this time, as shown in Equations 4 to 12 and Tables 9 to 19 described above, the terminal may receive SRS transmission-related information through higher-level signaling. The terminal may receive SRS transmission-related comb size information and PRB-related information through higher-level signaling, and through this, determine the comb size and the number of CSs. As another example, the terminal may receive comb size information related to SRS transmission through higher-level signaling and determine the comb size and the number of CSs through this. (S2020)

For example, when resources are allocated in units of 4 PRBs, since orthogonality may not be maintained based on the comb size and the maximum number of CSs, the number of PRBs may be changed, as described above. After that, the UE may perform SRS transmission based on the determined comb size and the number of CSs. (S2030)

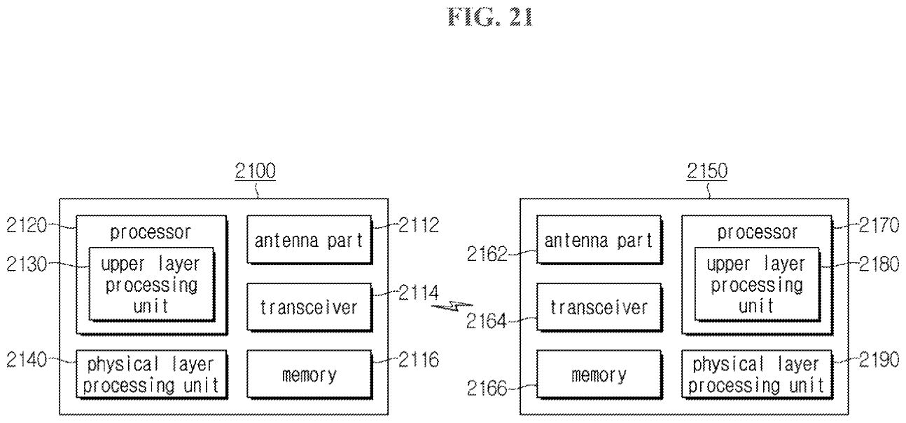

FIG. 21 is a diagram illustrating a base station device and a terminal device to which the present disclosure can be applied.

The base station apparatus 2100 may include a processor 2120, an antenna unit 2112, a transceiver 2114, and a memory 2116.

The processor 2120 performs baseband-related signal processing and may include an upper layer processing unit 2130 and a physical layer processing unit 2140. The upper layer processing unit 2130 may process operations of a medium access control (MAC) layer, a radio resource control (RRC) layer, or higher layers. The physical layer processing unit 2140 may process physical (PHY) layer operations (eg, uplink reception signal processing and downlink transmission signal processing). In addition to performing baseband-related signal processing, the processor 2120 may control overall operations of the base station device 2100.

The antenna unit 2112 may include one or more physical antennas, and may support multiple input multiple output (MIMO) transmission and reception when including a plurality of antennas. In addition, beamforming may be supported. Here, the antenna unit 2112 supports MIMO transmission/reception and beamforming through an antenna pattern in an antenna array including a plurality of antennas. Different antenna port indexes are assigned to antenna ports according to the transmitted channel type. In this case, since a plurality of antennas may have the same antenna port index, the actual number of physical antennas may be plural even when one antenna port is used. A plurality of antenna ports may be used in the SRS transmission. However, only one antenna port may be used in SRS transmission for positioning according to the present invention. The transceiver 2114 may include a radio frequency (RF) transmitter and an RF receiver.

The memory 2116 may store information processed by the processor 2120, software related to the operation of the base station device 2100, an operating system, an application, and the like, and may include components such as a buffer.

The processor 2120 of the base station 2100 may be configured to implement the operation of the base station in the embodiments described in the present invention.

The terminal device 2150 may include a processor 2170, an antenna unit 2162, a transceiver 2164, and a memory 2166. For example, in the present invention, the terminal device 2150 may communicate with the base station device 2100. As another example, in the present invention, the terminal device 2150 may perform sidelink communication with another terminal device. That is, the terminal device 2150 of the present invention refers to a device capable of communicating with at least one of the base station device 2100 and other terminal devices, and is not limited to communication with a specific device.

The processor 2170 performs baseband-related signal processing and may include an upper layer processing unit 2180 and a physical layer processing unit 2190. The upper layer processing unit 2180 may process operations of a MAC layer, an RRC layer, or higher layers. The physical layer processing unit 2190 may process PHY layer operations (eg, downlink reception signal processing and uplink transmission signal processing). In addition to performing baseband-related signal processing, the processor 2170 may also control overall operations of the terminal device 2150.

The antenna unit 2162 may include one or more physical antennas, and may support MIMO transmission and reception when including a plurality of antennas. In addition, beamforming may be supported. Here, the antenna unit 2112 supports MIMO transmission/reception and beamforming through an antenna pattern in an antenna array including a plurality of antennas. Different antenna port indexes are assigned to antenna ports according to the transmitted channel type. In this case, since a plurality of antennas may have the same antenna port index, the actual number of physical antennas may be plural even when one antenna port is used. A plurality of antenna ports may be used in the SRS transmission. However, only one antenna port may be used in SRS transmission for positioning according to the present invention. Transceiver 2164 may include an RF transmitter and an RF receiver.

The memory 2166 may store information processed by the processor 2170, software related to the operation of the terminal device 2150, an operating system, an application, and the like, and may include components such as a buffer.

Here, the processor 2170 of the terminal device 2150 may receive DL PRS configuration information from the base station 2100. In this case, the DL PRS configuration information may include comb size and DL PRS allocation pattern information as DL PRS reception related information. For example, the comb size may be 2, 4, 6 or 12. In addition, the DL PRS allocation pattern is derived based on Equation 3 so that orthogonality can be maintained even when frequency axis transposition and time axis transposition are performed. When the comb size is 6, the DL PRS allocation pattern may be {0,2, 1,4,5,3}. Also, when the comb size is 12, the DL PRS allocation pattern may be {0, 1,4,2,9,5,11,3,8,10,7,6}.

The processor 2170 of the terminal device 2150 receives the DL PRS from the base station 2100 based on the comb size and the DL PRS allocation pattern. The processor 2170 of the terminal device 2150 may perform location estimation based on the received DL PRS. Here, the DL PRS resource related ID is distinguished based on a time axis shift value and a frequency axis shift value based on the DL PRS allocation pattern. The processor 2170 of the terminal device 2150 receives the DL PRS from the base station 2100 based on the DL PRS resource related ID. For example, a PRS resource ID may correspond to each DL PRS resource. In this case, the PRS resource ID may have different frequency axis shift values and time axis shift values based on the DL PRS pattern. As another example, the frequency axis shift value and the time axis shift value may be different according to the PRS sequence ID, and through this, the DL PRS can be distinguished. As another example, the frequency axis shift value may be set differently according to the PRS resource ID. Additionally, a time axis shift value may be set differently according to the PRS resource set ID. As another example, the frequency axis shift value may be set differently according to the PRS resource ID. Additionally, a time axis shift value may be set differently according to the PRS sequence ID.

Also, the processor 2170 of the terminal device 2150 may receive bitmap information indicating DL PRS muting from the base station 2100. The processor 2170 of the terminal device 2150 performs DL PRS muting based on the received bitmap information. The bitmap information may include at least one of first bitmap information, second bitmap information, and third bitmap information. In this case, the first bitmap information may indicate muting for the DL PRS in units of occasions. In addition, the second bitmap information may indicate muting for DL PRS in repetition units within an occasion. Here, the repetition unit may be one slot. Also, as an example, the third bitmap information may indicate muting for the DL PRS based on the comb size in units of a plurality of symbols in repetition.

Also, the processor 2120 of the base station 2100 may transmit DL PRS configuration information from the terminal device 2150. In this case, the DL PRS configuration information may include comb size and DL PRS allocation pattern information as DL PRS reception related information. For example, the comb size may be 2, 4, 6 or 12. In addition, the DL PRS allocation pattern is derived based on Equation 3 so that orthogonality can be maintained even when frequency axis transposition and time axis transposition are performed. When the comb size is 6, the DL PRS allocation pattern may be {0,2, 1,4,5,3}. Also, when the comb size is 12, the DL PRS allocation pattern may be {0, 1,4,2,9,5,11,3,8,10,7,6}.

The processor 2120 of the base station 2100 transmits the DL PRS from the terminal device 2150 based on the comb size and the DL PRS allocation pattern. The terminal device 2150 may perform location estimation based on the received DL PRS. Here, the DL PRS resource related ID is distinguished based on a time axis shift value and a frequency axis shift value based on the DL PRS allocation pattern. The processor 2120 of the base station 2100 transmits the DL PRS to the terminal device 2150 based on the ID associated with the DL PRS resource. For example, a PRS resource ID may correspond to each DL PRS resource. In this case, the PRS resource ID may have different frequency axis shift values and time axis shift values based on the DL PRS pattern. As another example, the frequency axis shift value and the time axis shift value may be different according to the PRS sequence ID, and through this, the DL PRS can be distinguished. As another example, the frequency axis shift value may be set differently according to the PRS resource ID. Additionally, a time axis shift value may be set differently according to the PRS resource set ID. As another example, the frequency axis shift value may be set differently according to the PRS resource ID. Additionally, a time axis shift value may be set differently according to the PRS sequence ID.

Also, the processor 2120 of the base station 2100 may transmit bitmap information indicating DL PRS muting to the terminal device 2150. Through this, the terminal device 2150 performs DL PRS muting based on the received bitmap information. The bitmap information may include at least one of first bitmap information, second bitmap information, and third bitmap information. In this case, the first bitmap information may indicate muting for the DL PRS in units of occasions. In addition, the second bitmap information may indicate muting for DL PRS in repetition units within an occasion. Here, the repetition unit may be one slot. Also, as an example, the third bitmap information may indicate muting for the DL PRS based on the comb size in units of a plurality of symbols in repetition.

Also, the processor 2170 of the terminal device 2150 may receive SRS transmission related information for positioning from the base station 2100. For example, the processor 2170 of the terminal device 2150 may receive SRS transmission-related information from the base station 2100 through higher-level signaling. The processor 2170 of the terminal device 2150 may receive SRS transmission-related comb size information and PRB-related information through higher-level signaling, and determine the comb size and the number of CSs through this.

As another example, the processor 2170 of the terminal device 2150 may receive comb size information related to SRS transmission through higher-level signaling and determine the comb size and the number of CSs through this. Here, when resources are allocated in units of 4 PRBs, since orthogonality may not be maintained based on the comb size and the maximum number of CSs, the number of PRBs may be changed.

In addition, the processor 2120 of the base station 2100 may transmit SRS transmission-related information for positioning to the terminal device 2150. For example, the processor 2120 of the base station 2100 may transmit SRS transmission-related information to the terminal device 2150 through higher-level signaling. The processor 2120 of the base station 2100 transmits SRS transmission-related comb size information and PRB-related information to the terminal device 2150 through upper-level signaling, and the terminal device 2150 determines the comb size and the number of CSs through this. can

As another example, the processor 2120 of the base station 2100 may transmit SRS transmission-related comb size information to the terminal device 2150 through higher-level signaling. The terminal device 2150 may determine the comb size and the number of CSs through the received information. Here, when resources are allocated in units of 4 PRBs, since orthogonality may not be maintained based on the comb size and the maximum number of CSs, the number of PRBs may be changed.

Hereinafter, the industrial internet of things (IIoT) to which the present invention is applied includes devices such as sensors and equipment interconnected by a network together with industrial sectors of computers including manufacturing and energy management. Communication/connection of each unit according to the present invention includes being able to communicate through a system supporting an advanced communication technology based on 5G, NR wireless communication systems and LTE/LTE-A. The IIoT system to which this invention is applied is an evolution of the Distributed Control System (DCS), enabling a high level of automation by using cloud computing to improve process control. The IIoT system to which the present invention is applied may include a layered modular structure of digital technology. The user interface device of the IIOT system to which the present invention is applied may include a wireless processing device capable of processing applications and contents including screen configuration devices, tablets, smart grass, and the like. These wireless processing devices may include application software and processing units that analyze data and convert it into information. CPS, sensors, machines. The network layer includes a physical network bus, cloud computing, and communication protocols that collect and transmit data to the service layer, and this service layer is also implemented through a separate unit of the communication device that configures and processes the PRS and SRS according to the application of the present invention may include Therefore, the service layer of the IIoT system according to the present invention can be configured as an application that manipulates data and then merges this data into information that can be displayed on the driver dashboard, and the top layer, the content layer, that is, the screen through the user interface. and displayable through the wireless processing device through the display unit.

In addition, various embodiments of the present disclosure may be implemented by hardware, firmware, software, or a combination thereof. For hardware implementation, one or more application specific integrated circuits (ASICs), digital signal processors (DSPs), digital signal processing devices (DSPDs), programmable logic devices (PLDs), field programmable gate arrays (FPGAs), It may be implemented by a processor (general processor), controller, microcontroller, microprocessor, or the like.

The scope of the present disclosure is software or machine-executable instructions (e.g., operating systems, applications, firmware, programs, etc.) that cause operations in accordance with the methods of various embodiments to be executed on a device or computer, and such software or It includes a non-transitory computer-readable medium in which instructions and the like are stored and executable on a device or computer.

Various embodiments of the present disclosure are intended to explain representative aspects of the present disclosure, rather than listing all possible combinations, and matters described in various embodiments may be applied independently or in combination of two or more.

### INDUSTRIAL APPLICABILITY

The above can be applied to various systems.

What is claimed is:

1. A method for estimating a location of a terminal in a wireless communication system, the method comprising:
receiving downlink positioning reference signal (DL PRS) configuration information from a base station, wherein the received DL PRS configuration information comprises comb size and DL PRS allocation pattern information;
receiving a DL PRS from the base station based on the comb size and the DL PRS allocation pattern; and
estimating a position based on the received DL PRS;
wherein DL PRS resource related IDs are classified based on time axis shift values and frequency axis shift values based on the DL PRS allocation pattern, wherein the terminal receives the DL PRS based on the DL PRS resource related ID.

2. The method of claim 1,
the terminal receives bitmap information indicating the DL PRS muting from the base station, and performs the DL PRS muting based on the received bitmap information,
the bitmap information comprises at least one of first bitmap information, second bitmap information, and third bitmap information,
the first bitmap information indicates muting for the DL PRS in units of occasions,
the second bitmap information indicates muting for the DL PRS in units of repetition within the occasion;
the third bitmap information indicates muting for the DL PRS in units of a plurality of symbols within the repetition.

3. A method for estimating a location of a terminal in a wireless communication system, the method comprising:
receiving SRS (Sounding Reference Signal) transmission related information for positioning from a base station, wherein the SRS transmission related information comprises at least one of comb size information and PRB (Physical Resource Block) information;
determining a comb size and a number of cyclic shifts (CSs) based on the received SRS transmission-related information; and
transmitting an SRS based on the determined comb size and the determined number of CSs.
